(19) United States
(12) Patent Application Publication
(10) Pub. No.: US 2026/0252064 A1
(43) Pub. Date: Aug. 27, 2026

(54) SYSTEMS AND METHODS FOR DEEP LEARNING-DRIVEN NEUROSYMBOLIC TECHNIQUES FOR CORRELATION DISCOVERY, CAUSAL ANALYSIS, AND PRESCRIPTIVE RECOMMENDATIONS WITH KNOWLEDGE-BASED REASONING

(71) Applicant: Arizona Board of Regents on Behalf of Arizona State University, Tempe, AZ (US)

(72) Inventors: Mukund Shenoy, Chandler, AZ (US); Farhad Ameri, Gilbert, AZ (US)

(21) Appl. No.: 19/438,325

(22) Filed: Dec. 31, 2025

Related U.S. Application Data
(60) Provisional application No. 63/761,526, filed on Feb. 21, 2025.

(51) Int. Cl. G05B 19/418

(52) U.S. Cl. CPC G05B 19/41875; G05B 2219/32222; G05B 2219/45031

(57) ABSTRACT

A system implements a hybrid AI framework which integrates symbolic reasoning with data-driven approaches to enhance defect prediction and risk management in semiconductor manufacturing. The framework combines rule-based logic and deep learning to handle multi-modal data from design, process, equipment, and material sources (such as FMEAs, specifications, metrology, and sensor data) and provides insights into hidden patterns in the data, identification of root causes for observed issues, and actionable outputs tailored to domain-specific requirements.

### CROSS REFERENCE TO RELATED APPLICATIONS

The present document is a Non-Provisional patent application that claims benefit to U.S. Provisional Patent Application Ser. No. 63/761,526 filed on Feb. 21, 2025, which is herein incorporated by reference in its entirety.

### FIELD

The present disclosure generally relates to computer-aided quality control systems, and in particular, to a system and associated method for computer-aided defect diagnosis and quality control in industrial manufacturing using a neurosymbolic machine learning platform.

### BACKGROUND

Achieving zero-defect manufacturing remains a challenge in semiconductor manufacturing, given increasingly complex processes with reduced time to market. Current quality control and optimization methods often miss the broader impact of upstream data on downstream quality metrics.

It is with these observations in mind, among others, that various aspects of the present disclosure were conceived and developed.

### SUMMARY

The present disclosure provides a number of examples that describe computer-implemented neurosymbolic techniques and operations for detecting defects in a manufacturing process. In the context of the disclosed methods, devices, techniques, apparatus, systems, and so on, the terms “operable to,” “configured to,” and “capable of” used herein are interchangeable.

In a first set of illustrative examples, the computer-implemented neurosymbolic techniques are embodied by a method. The disclosed method uses a neurosymbolic approach to automatically diagnose manufacturing defects and suggest concrete process changes. Multimodal manufacturing data is collected, including specification limits (for example, target values and tolerances for process parameters and product qualities) and the actual measurements observed on the line. The multimodal data is then mapped into an ontological knowledge graph that explicitly links each measured value to its corresponding specification and captures known causal relationships between processes, equipment, parameters, and defects.

On top of this graph, a processor runs physics-informed rules expressed as queries over the knowledge graph. These rules compare the observed measurements to their specification limits, detect deviations, and, when a deviation is found, assert “failure-cause” nodes and directed causal links connecting the deviation to any observed defect. By traversing these nodes and links, the processor assembles a causal chain from the defect back through intermediate mechanisms to one or more underlying failure causes. Based on this causal chain, the processor generates a remedial instruction that identifies specific modifications to one or more process parameters and causes a corresponding manufacturing system to apply those modifications in subsequent runs, thereby reducing the incidence of the diagnosed defect.

In a second set of illustrative examples, the computer-implemented neurosymbolic techniques are embodied by a system including a at least one processor and instructions embodied via computer-readable media or memory that cause the processor to performed various instructions. In essence, the disclosed system provides a neurosymbolic “brain” for diagnosing manufacturing defects and recommending how to fix them. It includes the one or more processors and the memory that stores instructions to perform the defect-diagnosis workflow. Using these instructions, the system ingests multimodal manufacturing data, such as specification limits and measured values from sensors and inspection tools, and organizes that data into an ontological knowledge graph. The knowledge graph captures domain entities (for example, products, processes, equipment, parameters, and defects) as well as causal relationships between them.

On top of this knowledge graph, the system executes physics-informed rules that evaluate whether the measured observations conform to their specifications. When the rules detect a deviation, the system writes “failure cause” nodes and directed causal links into the graph, connecting the deviation to any observed defect. By traversing these nodes and links, the processors assemble a causal chain from each defect back to one or more underlying causes. Based on this causal chain, the system generates remedial instructions that identify specific changes to process parameters of a manufacturing system, enabling the manufacturing environment to be adjusted in a targeted way to reduce recurrence of the diagnosed defects.

In some examples, the instructions that cause the at least one processor to assemble the causal chain further cause the at least one processor to identify, as a root cause, a failure-cause assertion that lacks any upstream directly-causally-influencing failure-cause assertion in a subgraph associated with the observed defect, and to select, based on the root cause, at least one corrective-action specification stored in association with the ontological knowledge graph for inclusion in the remedial instruction.

Other illustrative examples are contemplated including computer-readable media, etc. The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a system schematic of a neurosymbolic artificial intelligence (AI) framework which integrates physics-aware symbolic representation of causal analysis and neural network detected features based on correlation analysis.

FIG. 2A is a graphical representation showing an example of a Ontology-based Knowledge Graph.

FIG. 2B is a flow chart representing example Siddhant ontology: a structured representation of equipment, defects, specifications, and processes as described herein.

FIG. 3 is a graph illustrating physics-based surface mount technology (SMT) reflow temperature profile specification defining process constraints.

FIG. 4 is an illustration of ontology-based causal reasoning for solder bridging detection and corrective action recommendation.

FIG. 5A is a distribution/histogram report showing temporal draft in false/true negatives by month.

FIG. 5B is a correlation heat map for key inspection features.

FIG. 6A is a performance benchmarking model showing area under curve (AUC) performance comparison across multiple models.

FIG. 6B is a chart illustrating top 10 feature importance scores for the best-performing XGBoost model, illustrating key predictive features.

FIG. 7 is an illustration of anomalies that often originate during early printing and placement steps but manifest as defects downstream, across printing→placement→reflow→AOI/test, motivating causal reasoning over multi-stage SMT process data.

FIG. 8 is an illustration of a causal reasoning framework described herein. Equipment and information systems feed data into a staging layer; the semantic layer performs data ingestion, quality validation, and ontology-driven KG generation; the reasoning layer applies rules and classification to extend the KG; and the decision-support layer orchestrates RCA, presents results, and feeds back recommendations to process control.

FIG. 9 is an illustration of a legend indicating source ontologies for classes used in subsequent ontology figures.

FIG. 10 is an illustration of a specification-observation-conformance assessment pattern. Qualities inherent in material products and are constrained by specifications; observations record realized values and are evaluated against specifications; conformance assessments take specification-observation pairs as input and classify conformity for downstream reasoning.

FIG. 11 is an illustration of a disposition-realization-failure cause pattern. A disposition inheres in a material entity, is triggered by a manufacturing process, is realized in a mechanism-specific process, and results in a deviation represented as a FailureCause. Conformance assessments occur post hoc and identify, rather than generate, the failure cause with provenance.

FIG. 12 is an illustration of a cause-effect-corrective action pattern. Failure causes are linked by RO causal predicates to form chains that terminate in defects; root causes are the most upstream failure causes in these chains; corrective-action specifications are attached to root causes via corrects.

FIG. 13 is an illustration of representative physics-aware causal rules. Rules encode geometric, kinematic, and process-chemistry conditions that, when violated, instantiate failure causes associated with the ApertureOverfill or PostPrintSpread mechanisms.

FIG. 14 is a SPARQL template implementing the combined aperture-area-ratio/stencil-thickness rule. When either the area ratio is below its lower specification limit or the stencil thickness exceeds its upper limit, the query constructs a ConformanceAssessment and an ApertureOverfill failure cause, linked to the governing disposition, observations, specifications, and product.

FIG. 15 is a SPARQL query for CQ1: causes of the defect on PCB17. The query returns immediate cause-effect pairs for a given product using the RO: directlyCausallyInfluencedBy relation.

FIG. 16 is a CQ1 result table for PCB17: immediate cause-effect pairs extracted from the knowledge graph.

FIG. 17 is a CQ1 causal analysis for PCB17. The graph shows parameter-level causes, mechanisms, and the solder-bridging defect connected by RO: directlyCausallyInfluencedBy and inferred RO: causallyInfluencedBy relations.

FIG. 18 is a CQ5 result: domain-level causal reasoning knowledge for solder bridging. The graph aggregates all modeled causes that participate in solder-bridging chains.

FIG. 19 is a graphical representation showing an example computing device for implementation of aspects of the neurosymbolic AI framework of FIG. 1.

FIG. 20 is a simplified diagram showing an example neural network architecture model for implementation of aspects of the neurosymbolic AI framework of FIG. 1.

Corresponding reference characters indicate corresponding elements among the view of the drawings. The headings used in the figures do not limit the scope of the claims.

### DETAILED DESCRIPTION

The present disclosure outlines a system and associated methods for defect diagnosis and quality control in semiconductor manufacturing using neurosymbolic artificial intelligence (AI). By integrating knowledge graphs, ontologies, and deep neural networks, the approach harmonizes human expertise and machine learning to predict, diagnose, and mitigate defects in real time. Focusing on Failure Mode and Effects Analysis (FMEA) and other expert sources, the research transforms this knowledge into structured physics-aware ontologies and knowledge graphs to enable seamless integration with neural networks. Additionally, novel ensemble neural network architectures are explored to leverage the full potential of physics-aware neurosymbolic techniques.

In some aspects, the techniques described herein relate to a system, including: a processor in communication with a memory, the memory including instructions executable by the processor to: map a set of multimodal input data to an ontological knowledge graph; identify, by application of the multimodal input data as input to a neural network model and based on rule-based causal information obtained using the ontological knowledge graph, one or more correlations between one or more factors and one or more outcomes observable within the multimodal input data; and generate, based on the one or more correlations, a corrective action prediction for remediation of one or more problematic outcomes associated with the one or more factors observable within the multimodal input data.

In some aspects, the techniques described herein relate to a system, the memory further including instructions executable by the processor to: apply a feature engineering or dimensionality reduction technique to the multimodal input data.

In some aspects, the techniques described herein relate to a system, the memory further including instructions executable by the processor to: identify one or more process deviations associated with the one or more problematic outcomes and the one or more factors observable within the multimodal input data.

In some aspects, the techniques described herein relate to a system, the memory further including instructions executable by the processor to: predict a potential defect for a product associated with the one or more factors observable within the multimodal input data.

In some aspects, the techniques described herein relate to a system, the set of multimodal input data including manufacturing system information and the one or more problematic outcomes including a product defect.

In some aspects, the techniques described herein relate to a system, the set of multimodal input data including patient health information and the one or more problematic outcomes including disease symptoms.

In some aspects, the techniques described herein relate to a system, the set of multimodal input data including supply chain information and the one or more problematic outcomes including supply chain disruptions.

The functions performed in the processes and methods described herein may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### I. Problem Statement

Achieving zero-defect manufacturing remains a challenge in semiconductor manufacturing, given increasingly complex processes with reduced time to market. While manufacturing processes are optimized to ship high-quality products, monitoring product performance in the field is equally important to provide feedback for continuous manufacturing improvements. Today, rule-based local optimization methods are widely used to control quality at individual process steps. However, these methods miss the broader impact of upstream data on downstream quality metrics for an end-to-end global optimization, leading to higher-than-modeled defect rates and challenging excursions.

The systems outlined herein pertain to AI, particularly Neurosymbolic AI, which combines the strengths of deep learning, machine learning, and symbolic reasoning to enhance the explainability, accuracy, and scalability of AI systems. In domains where high-stakes decisions rely on both human expertise and vast data patterns—such as semiconductor manufacturing, healthcare diagnostics, and supply chain optimization—traditional AI methods often fall short due to their “black box” nature and lack of domain-specific reasoning.

Advancements in deep learning have revolutionized AI's ability to detect patterns, predict outcomes, and classify data. However, these systems struggle to incorporate structured domain knowledge or explain their decisions, particularly in scenarios involving physics-aware models or human expertise. On the other hand, symbolic AI methods, like ontologies and knowledge graphs, excel in capturing and reasoning with structured knowledge but lack adaptability to large, complex datasets.

Recognizing this gap, the development of Deep Learning-Driven Neurosymbolic Techniques was driven by the need to harmonize data-driven and knowledge-driven approaches. The systems outlined herein address a critical challenge: integrating correlation discovery, causal analysis, and prescriptive recommendations while maintaining interpretability and leveraging human and physics-based expertise. The systems outlined herein are adaptable across industries requiring robust, scalable, and explainable AI solutions.

### II. Literature Review

Recent research has explored AI and ontologies in manufacturing, focusing on defect prediction, risk management, and knowledge extraction. While advancements have been made, opportunities remain to improve the integration of symbolic AI and physics-aware reasoning with predictive analytics.

Bahr et al. highlight the benefits of knowledge graph integration for FMEA data using a Retrieval-Augmented Generation (RAG) framework but suggest further development of symbolic reasoning for enhanced defect prediction. Psarommatis et al. propose a Zero Defect Manufacturing ontology, which addresses quality assurance but leaves room for better handling of multi-stage defect propagation. Hodkiewicz et al. develop an ontology for FMEA spreadsheets to enable automated reasoning, though integration with real-time predictive models could enhance its utility. Razouk et al. propose an AI-based system for root cause analysis in semiconductor manufacturing, which could benefit from incorporating symbolic reasoning for multi-stage defect detection. Hasan and Patel identify limitations in knowledge graph embeddings for representing logical rules, pointing to the need for enhanced symbolic reasoning in predictive defect analytics.

### III. Inventive Neurosymbolic Framework

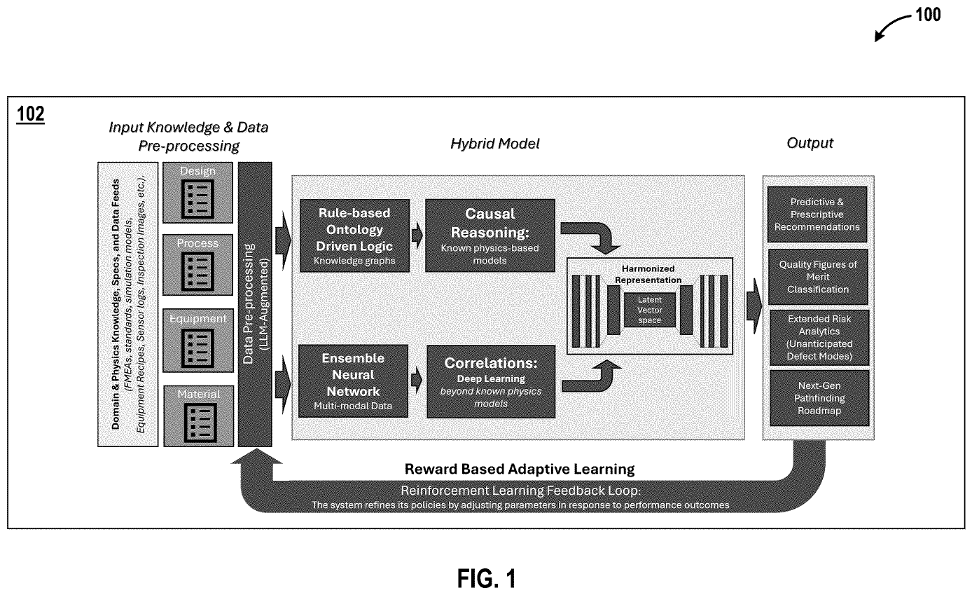

Referring to FIG. 1, a computer-implemented system 100 as referenced and further described herein implements a hybrid AI framework 102 that integrates symbolic reasoning with data-driven approaches to enhance defect pre-diction and risk management in semiconductor manufacturing. The framework 102 combines rule-based logic and deep learning to handle multi-modal data from design, process, equipment, and material sources, such as FMEAs, specifications, metrology, and sensor data. In other words, the framework 102 unites symbolic reasoning with deep learning for defect detection, root cause analysis, and process optimization. By encoding domain knowledge in ontologies and knowledge graphs while simultaneously leveraging advanced neural models, the framework 102 produces both predictive and prescriptive outputs.

The framework operates through two pathways illustrated in FIG. 1:

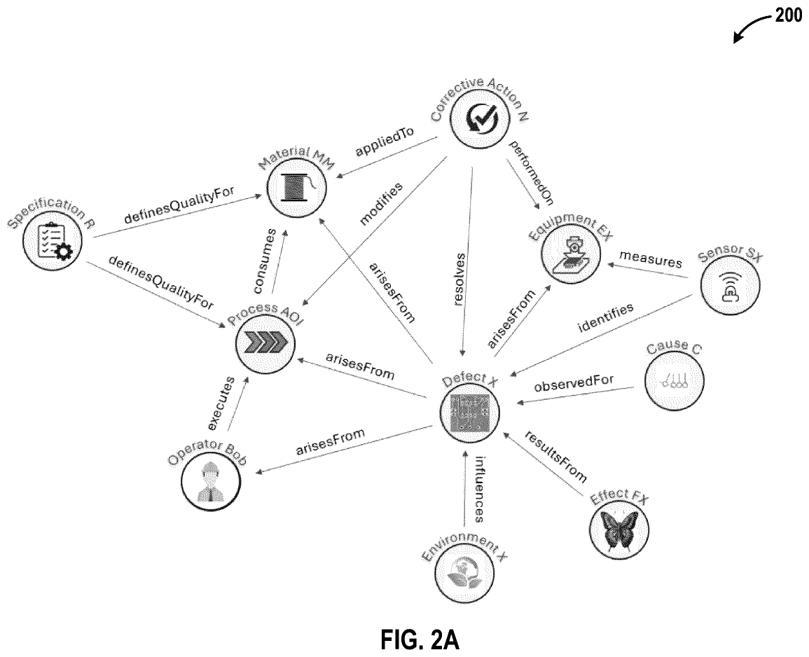

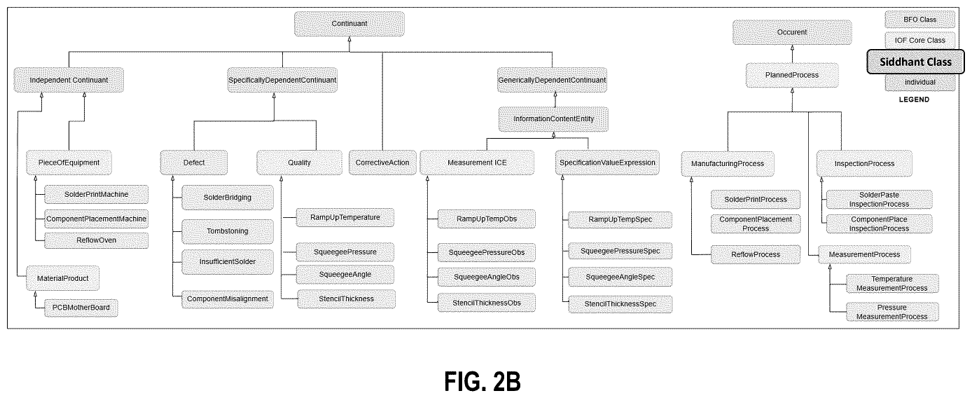

1. Rule-Based Logic: Utilizes ontologies and knowledge graphs (an example knowledge graph 200 is shown in FIG. 2A) for causal inference and defect identification based on physics models.

2. Multi-Modal Data Processing: Employs deep neural networks to detect correlations in complex data where physics-based models fall short.

These pathways converge into a harmonized latent vector space, fusing symbolic and data-driven insights for comprehensive causal reasoning and correlation detection. This integration supports both defect prediction and the discovery of unanticipated defects, improving overall risk management. The hybrid approach addresses the complexities of semiconductor manufacturing by combining traditional knowledge with advanced AI techniques aligned with the industry's needs for predictive analytics, quality control, and process optimization.

The framework 102 implements introduces Deep Learning-Driven Neurosymbolic Techniques that integrate machine learning, neural networks, and deep learning with knowledge-based reasoning frameworks to enable advanced correlation discovery, causal analysis, and prescriptive recommendations. The framework 102 captures and harmonizes human expertise and physics-aware domain knowledge through ontology and knowledge graph-based structures, augmenting data-driven models with interpretability and domain-specific insights.

Objectives of the framework 102 include addressing limitations in traditional AI systems by integrating structured knowledge representations with data-driven predictions, ensuring scalability, explainability, and actionable outcomes. By leveraging the strengths of symbolic reasoning and neural learning, this approach achieves robust performance across diverse, high-complexity scenarios such as defect prediction, risk assessment, and decision optimization in industrial and non-industrial domains.

The framework 102 has broad applications in fields requiring high precision and explainability, including semiconductor manufacturing, healthcare diagnostics, and supply chain resilience. The framework 102 represents a significant advancement in hybrid AI methodologies, combining statistical and symbolic reasoning for real-world problem-solving. The framework 102 may significantly impact industries by improving decision-making, enhancing operational efficiency, and reducing errors.

### Example Components

1. Machine Learning and Deep Neural Networks—These models are used for analyzing large-scale, high-dimensional data to uncover complex, non-linear correlations and patterns. Deep learning models, such as convolutional neural networks (CNNs) and graph neural networks (GNNs), process diverse datasets like sensor data, equipment logs, and inspection results.

2. Ontology and Knowledge Graph-Based Reasoning—Ontologies provide a structured, physics-aware representation of domain-specific knowledge, including processes, equipment, materials, and causal relationships. Knowledge graphs link entities and their relationships, allowing for advanced reasoning and inference.

3. Integration Techniques—The subject inventive concept harmonizes symbolic (ontology/graph) and statistical (deep learning) reasoning using a harmonized latent vector space. Symbolic reasoning guides model interpretability and ensures alignment with domain constraints, while neural networks provide adaptability and predictive power.

### Execution:

1. Data Preprocessing—Multimodal data (structured and unstructured) is cleaned, normalized, and mapped into the ontology/knowledge graph format. Feature engineering and dimensionality reduction are applied to enhance the efficiency of neural models.

2. Training and Reasoning—Deep learning models are trained to detect correlations and predict outcomes based on historical and real-time data. Ontology-based rules and knowledge graphs provide causal analysis by linking observed outcomes with underlying factors.

3 Prescriptive Analysis—The system prescribes actionable recommendations based on the integration of neural predictions and symbolic reasoning. For example, in manufacturing, the model identifies process deviations, predicts potential defects, and suggests corrective actions.

### A. Data Inputs and Unified Processing

In some examples, the system ingests diverse sources-process parameters, equipment logs, material properties, sensor data, metrology results, FMEAs, and design specs-requiring robust data standardization. A large language model (LLM)-augmented natural language processing (NLP) pipeline extracts relevant context from unstructured documentation, aligning features semantically with the ontology-driven knowledge base to ensure data interoperability.

### B. Symbolic+Neural Pathways

Symbolic AI Pathway: Encodes manufacturing expertise (causal rules, domain constraints) in ontologies. Allows for logical inference and interpretability in defect analysis, risk assessment, and corrective actions.

Neural Network Pathway: Processes high-dimensional signals (sensor, image) with ensemble deep models (e.g., CNNs, RNNs) to detect correlations and subtle defect patterns. These data-driven insights inform symbolic rules about emerging failure modes or unknown feature relationships.

### C. Integrated Reasoning and Outputs

A shared latent space fuses neural feature embeddings with symbolic constraints. Graph Neural Networks (GNNs) reconcile rule-based logic and learned patterns, enabling the following.
Predictive & Prescriptive Guidance: Actionable recommendations for preventing future defects and optimizing manufacturing steps.
Extended Risk Analytics: Detection of novel defect scenarios and upstream/downstream causal connections.
Quality Metrics & Road mapping: Data-driven identification of key figures of merit and strategic process improvements.

Real-world validations of the framework 102 focus on scalability and adaptability, ensuring the framework's capacity to deliver interpretable, physics-aware, and continually refined decision support in semiconductor manufacturing.

Use Cases of the framework 102:
Manufacturing Systems (predicting semiconductor defects, diagnosing root causes, and suggesting process adjustments);
Healthcare (classifying patient data, diagnosing diseases, and recommending treatments by integrating medical guidelines with neural models);
Supply Chain Management (anticipating disruptions, analyzing root causes, and optimizing logistics plans).

Key Outputs:
Correlation Discovery: Insights into hidden patterns in the data.
Causal Analysis: Identification of root causes for observed issues.
Prescriptive Recommendations: Actionable outputs tailored to domain-specific requirements.

The detailed integration of neural models and symbolic systems makes the subject inventive concept highly adaptable and robust, enabling seamless application in complex, real-world scenarios.

### IV. Specific Non-Limiting Case Study: SMT Manufacturing

A case study was conducted to apply the framework 102 of FIG. 1 to Surface Mount Technology (SMT) assembly, focusing on the defect mode of solder bridging, which causes electrical shorts. Surface Mount Technology (SMT) assembles PCBs through multi-step processes (printing, placement, reflow) where parameter anomalies at one stage can surface as defects in later stages. Process engineers currently rely on methods like FMEA and Ishikawa (fishbone) diagrams to diagnose issues (e.g., solder bridging), but these approaches often treat each process step in isolation. Physics-based specifications (thermal profiles, stencil design) ensure operational windows, yet downstream defects can still emerge due to variabilities in materials, equipment, or environment. For instance, excessive ramp-up temperature during reflow may cause solder bridging only discovered at final inspection. Root cause analysis becomes more complex across the supply network, from component suppliers to PCB assemblers. The framework 102 was tested in this context and it was discovered that the framework 102 unifies these design, process, and equipment constraints with real-time data to holistically model failures. In the following, the ontology-based reasoning is instantiated on the solder-bridging scenario as a representative SMT defect.

### V. Symbolic AI: Structured Knowledge Capture

An ontology is a structured, formal representation of domain concepts, their attributes, and the relationships among them. In the context of knowledge engineering, ontologies are widely used to encode expert knowledge in a consistent, machine-interpretable manner, thereby enabling automated reasoning and semantic interoperability. Semiconductor manufacturing, with its sophisticated processes and large volumes of specialized data, benefits significantly from such ontology-driven representations.

As one aspect of the inventive concepts described herein, an ontology referred to as “Siddhant” is presented; an ontology for capturing physics-based manufacturing knowledge in semiconductor assembly. Siddhant is used herein as a non-limiting label for an example implementation; the disclosed methods and systems are not limited to any particular nomenclature.

Siddhant is built on top of the Basic Formal Ontology (BFO) and Industrial Ontologies Foundry (IOF) core modules, ensuring alignment with well-established, domain-agnostic upper ontologies. FIG. 2B depicts Siddhant's class structure, subdivided into continuants (e.g., physical entities and their dependent attributes) and occurrents (e.g., manufacturing and inspection processes).

In some examples, Siddhant models key entities and their relationships are as follows (class names match FIG. 2B).
Equipment (PieceOfEquipment): Represents machines such as SolderPrintMachine, ComponentPlacementMachine, and ReflowOven. These classes capture machine capabilities and configuration details that can be essential for process parameterization.
Material (MaterialProduct): Encompasses items like PCBMotherBoard, solder paste, or other raw materials. Material properties (e.g., viscosity, thickness) are systematically linked through Specification ValueExpression.
Defect (Defect): Classifies failure modes including SolderBridging, Tombstoning, and ComponentMisalignment. Siddhant employs object properties such as describes and isOutputOf to interrelate processes and defects.
Quality (Quality): Describes key process and product attributes (e.g., RampUp Temperature, SqueegeePressure) that inhere in or are realized by processes and materials. These measured qualities are captured under Measurement ICE.
Corrective Action (CorrectiveAction): Indicates interventions such as adjusting the oven temperature (RampUpTemperature) or modifying StencilThickness, linked via properties like remedies and isCauseOf.
Measurement (Measurement Information Content Entity): Encodes sensor readings (e.g., RampUpTempObs, SqueegeeAngleObs) used in process monitoring. These are paired with Specification ValueExpression (e.g., RampUpTempSpec) through properties such as prescribes and hasSpecifiedOutput.
Manufacturing Process (ManufacturingProcess): Includes SolderPrintProcess, ComponentPlacementProcess, and ReflowProcess. Properties like participatesin and hasOutput capture interactions among machines, materials, and the resulting defects or products.
Inspection Process (InspectionProcess): Encompasses SolderPasteInspectionProcess and MeasurementProcess (e.g., TemperatureMeasurementProcess, PressureMeasurementProcess). These processes detect deviations, linking measurement outcomes to potential defects.
   A. Causal Reasoning in Siddhant: Bridging Physics-Based Models with AI

Traditional root cause analysis in semiconductor manufacturing relies on expert-driven methodologies such as FMEA and Ishikawa diagrams. These methods systematically decompose failure causes but lack automated reasoning capabilities. Siddhant formalizes this knowledge by encoding causal relationships, allowing automated inference to link upstream process variations to downstream defect formation.

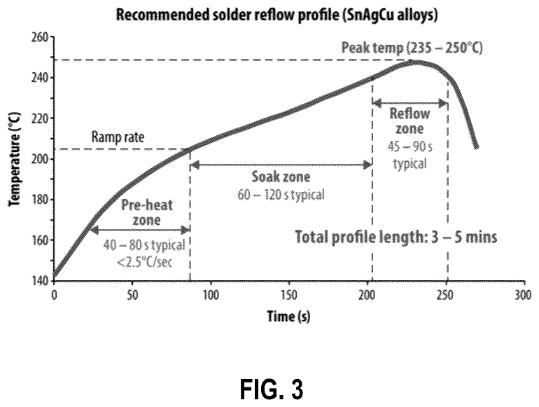

A key example is solder bridging in SMT manufacturing, where excessive ramp-up temperature in the reflow process can lead to unintended solder connections. The reflow thermal profile, shown in FIG. 3, defines critical parameters such as heating rate, peak temperature, and time above liquidus. These constraints are embedded in SIDDHANT through object properties like prescribes and hasSimple ValueExpression, enabling machine-interpretable process validation.

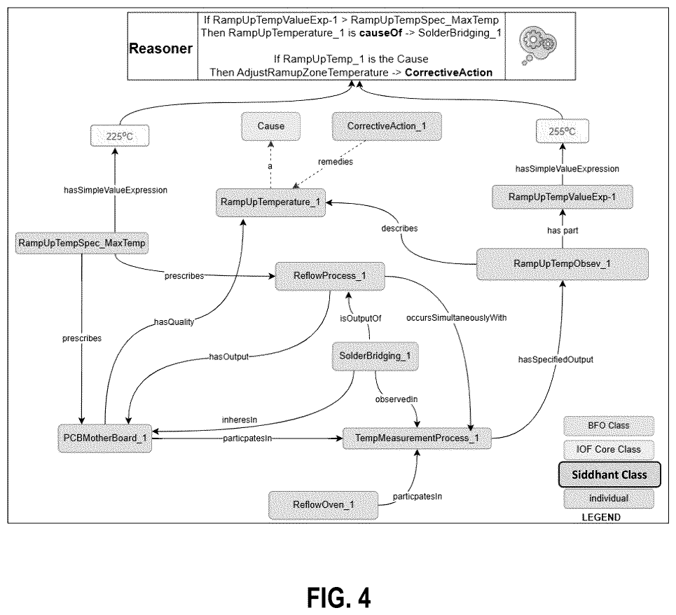

To illustrate deterministic reasoning in SIDDHANT, consider a scenario where a trained neural network detects and classifies solder bridging from multi-modal manufacturing data. The ontology reasoner then leverages encoded axioms and structured process knowledge to establish causal links and recommend corrective actions. As depicted in FIG. 4, when an observed RampUpTemperature exceeds the MaxTemp specification, SIDDHANT infers that solder bridging occurs due to an out-of-spec ramp-up zone temperature. The reasoner identifies this as the likely root cause and prescribes corrective actions, such as adjusting the ramp-up temperature, to restore process stability.

By integrating defect prediction and classification through an ensemble of trained neural networks with root cause analysis and corrective action determination via expert-defined causal rules encoded in ontologies and knowledge graphs, SIDDHANT bridges the gap between black-box classification and explainable, physics-aware decision-making. This fusion enables automated reasoning that not only identifies defects but also traces their root causes and prescribes targeted process adjustments, enhancing both the precision and adaptability of semiconductor manufacturing.

### VI. Neural Pathway: Multi-Modal Learning

With the goal of benchmarking multiple machine learning and neural network models on real-world datasets, several publicly available sources were surveyed, including SMT defect image archives. Although these datasets contained labeled records, none provided the semantic context needed to fully exploit the subject neurosymbolic framework (102). However, a publicly released dataset by Siemens AG offered an opportunity to investigate model performance characteristics and yield-improvement insights.

### A. Industrial Dataset Description

The Siemens AOI dataset spans 132 days of production, capturing 440,274 inspection records. Its inspection features, anonymized to protect proprietary data, exhibit real-world complexities such as shifting defect distributions over time-posing a challenge that necessitates adaptive learning techniques. A focus was made on feature quality, temporal drift, and class imbalance to better understand how well different models can maintain predictive accuracy under these industrial conditions.

### B. Feature Analysis and Data Insights

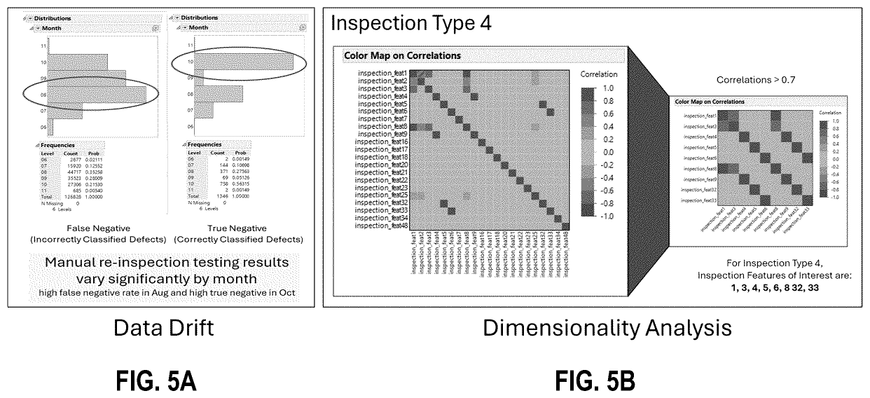

FIGS. 5A-5B highlight temporal fluctuations in classification outcomes, indicating drift that can degrade long-term model performance. Multivariate and principal component techniques were also employed to reduce dimensionality and enhance model efficiency. These steps underscore that real manufacturing data often requires preprocessing-removing noise, handling missing values, and curating features-before training robust predictive models. High false negative rates in certain months indicate shifting defect distributions, while strong inter-feature correlations guide dimension reduction strategies.

### C. Model Benchmarking and Performance

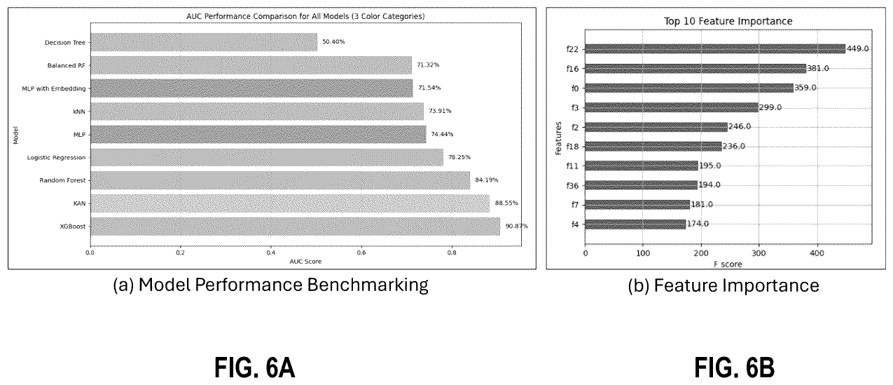

Several algorithms were evaluated, including Machine Learning (ML) including XGBoost, Balanced Random Forest as well as Deep Learning (DL) including Multi-Layer Perceptron (MLP) and Kolmogorov-Arnold Network (KAN) among others, to compare classification efficacy:
XGBoost: Delivered the highest AUC and interpretable feature rankings (FIGS. 6A-6B).
KAN: Demonstrated resilience to drift, indicating suitability for evolving process conditions.
Balanced Random Forest: Effectively addressed class imbalance, improving recall on rare defects.

As shown in FIGS. 6A-6B, experiments conducted with the Siemens dataset and other image sets demonstrate that ensemble and deep-learning methods effectively classify defects across multi-modal inputs when well-trained. Key predictive features were identified, yet lacking their semantic context prevented from fully applying the neurosymbolic AI framework (102) described herein.

### D. Key Observations and Industry Appeal

The present study reinforces several important points:
(1) Real industrial data demands thorough preparation and cleaning to achieve meaningful model performance.
(2) Handling temporal drift is critical, particularly when defect distributions shift over time.
(3) Post-hoc interpretation methods (e.g., SHAP or LIME) are indispensable for feature attribution and transparency.

Moving forward, including semantic descriptions of features would further empower explainable AI solutions-such as the proposed neurosymbolic approach- and foster deeper collaboration between industry and academia. The next section outlines how these findings integrate with the symbolic reasoning framework (102) to advance zero-defect manufacturing.

### VII. Integration: Bridging Symbolic AI and Neural Networks

Achieving explainable and adaptable AI in semiconductor defect analysis necessitates a seamless integration between symbolic AI and deep learning. Symbolic AI, through ontologies and knowledge graphs, offers structured causal reasoning, ensuring transparency and interpretability, whereas deep learning models excel at identifying nuanced patterns from multimodal sensor and image data. Yet, symbolic AI alone is limited by rigid rule-based structures, and deep learning operates as an opaque system. A hybrid approach is critical-one that leverages the strengths of both methodologies to provide a scalable and explainable AI-driven root cause analysis (RCA).

Graph Neural Networks (GNNs) serve as the fusion layer, harmonizing structured symbolic knowledge with learned feature representations from deep learning. This integration unfolds through three key steps:
Ontology-Driven Graph Construction: The manufacturing knowledge base is transformed into a structured graph representation where defects, processes, and equipment are nodes, and their relationships-both deterministic and statistical-form edges. This allows explicit modeling of process deviations and defect causality.
Embedding Neural Network Outputs: CNNs trained on AOI and X-ray images, as well as LSTMs analyzing time-series sensor data, generate rich feature embeddings. These are mapped onto graph nodes, merging data-driven insights with structured knowledge.
Hybrid Reasoning via GNNs: GNNs propagate information across the graph, reconciling discrepancies between predefined causal rules and observed defect patterns. This enables AI-driven RCA to align with domain-expert knowledge while uncovering hidden correlations that ontologies alone might overlook.

A critical challenge in this integration is resolving conflicts between rule-based logic and data-driven predictions. When symbolic inference and deep learning disagree—such as when an ontology-based rule attributes a defect to a stencil misalignment, while the neural model suggests an issue with reflow conditions—the approach herein prioritizes confidence-weighted fusion. If the neural network outputs a high-confidence prediction, its insights are incorporated while prompting an ontology update. Conversely, when confidence is low, symbolic rules guide decision-making. Failure Mode and Effects Analysis (FMEA) plays a key role in this process, serving as a structured framework to validate AI-generated insights against known failure modes and risk assessments. By embedding FMEA principles into the ontology, the system can weigh AI-driven classifications against established defect failure pathways, ensuring that deviations align with industrial knowledge and historical defect trends.

To further enhance adaptability, it is contemplated to automate the FMEA generation process by leveraging structured, semi-structured, and unstructured data from enterprise expertise, such as SMT process specifications, material properties, equipment configurations, best practices, and reliability data. By systematically capturing this information in a continuously evolving knowledge base, the system will dynamically refine risk models and defect classifications in response to newly observed patterns.

Additionally, reinforcement learning (RL) is critical for bridging expert feedback with both ontology-based and data-driven strategies. Under an RL framework, experts continuously validate or correct defect classification decisions, shaping a reward mechanism that emphasizes traceability and alignment with annotated FMEAs. Confidence-weighted fusion also emerges as a byproduct of knowledge-aware decision-making: subject matter experts and domain rules help define how to weight symbolic and neural inferences, thereby improving conflict resolution between the two.

The promise of neurosymbolic integration goes well beyond defect classification—enabling advanced capabilities in root cause analysis, prescriptive recommendations, and other facets of manufacturing intelligence. Future efforts will focus on refining these conflict resolution strategies, optimizing in-line computational efficiency, and continuously extending knowledge representations to accommodate emerging defect modes, thereby ensuring a robust and scalable AI-driven semiconductor manufacturing pipeline.

### V. Example Contributions

The present hybrid AI approach combines symbolic knowledge, encoded through ontologies, with deep neural networks for explainable AI systems, demonstrated through FMEA-based SMT assembly quality assessment. Insights from embedding techniques in link prediction and node classification, especially in capturing logical dependencies and symbolic reasoning within ontologies. Extending FMEA and Risk Analysis through symbolic reasoning applied to neural network outputs, leveraging vector space embeddings and rule-based inference to discover unanticipated defect modes in SMT manufacturing.

In addition, the scalable methodology described is adaptable to various semiconductor manufacturing environments. Insights into structured, unstructured, and semi-structured data pre-processing and integration to ensure robust, explainable output.

This disclosure presents the framework 102 which leverages ontologies and knowledge graphs, as a result of collaboration between academia and industry experts. The emphasis of this disclosure is on computer-implemented systems for ontology-driven reasoning for defect prediction and risk analysis. Use of graph neural networks for vector embedding and integration with ensemble neural networks is further contemplated for implementation of the framework 102. Synthetic datasets may be used for validation. The framework 102 can be scaled further using real-world manufacturing data to reduce false-positive rates and gain a more granular understanding of defect propagation across process stages.

Integration of Symbolic and Statistical Reasoning: Unlike traditional AI systems, the systems outlined herein seamlessly integrate symbolic reasoning frameworks (ontologies and knowledge graphs) with machine learning and deep neural networks. This dual approach enables both high-performance predictive modeling and interpretability, addressing a key gap in current AI technologies.

Harmonized Latent Vector Space: A unique harmonized vector space is introduced to align symbolic representations (e.g., causal relationships from ontologies) with learned neural embeddings. This integration ensures that the system can utilize domain-specific knowledge alongside data-driven insights, enabling more accurate and explainable decision-making.

Physics-Aware and Human Expertise Integration: The systems outlined herein incorporate physics-based models and human expertise into the AI system through knowledge-based reasoning. This aspect enables the system to provide domain-aligned outputs, making it particularly effective in scenarios where domain constraints and human reasoning are critical.

Prescriptive Recommendations: Beyond prediction and classification, the systems outlined herein provide actionable recommendations informed by both neural models and structured knowledge. This capability enhances its utility in operational decision-making, making it a comprehensive solution for real-world challenges.

Scalable Multimodal Data Handling: The systems outlined herein support the integration of diverse input data types (e.g., structured, unstructured, real-time sensor data) into a unified reasoning framework. This scalability ensures adaptability to complex, multi-source industrial environments.

Sustainability and Cost Reduction: By identifying root causes and prescribing corrective actions, the systems outlined herein reduce waste, resource consumption, and production costs, contributing to sustainable industrial practices.

### Further Examples & Example Implementations

Physics-Informed, Provenance-Aware Root-Cause Analysis with Explainable Corrective Action Decision Support for Zero-Defect SMT Assembly

Achieving zero-defect manufacturing (ZDM) in semiconductor assembly requires root-cause analysis (RCA) methods that do more than flag excursions-they must produce explanations and corrective actions that are consistent with process physics, auditable, and usable in day-to-day quality engineering workflows. The following builds upon the previous sections and presents an explainable, physics-informed causal RCA framework for surface-mount technology (SMT) assembly that trans-forms heterogeneous line data (specifications, measurements, inspection out-comes, and troubleshooting knowledge) into provenance-linked causal chains connecting parameter deviations to mechanisms, defects, and corrective actions. The framework operationalizes three recurring reasoning patterns—Specification-Observation-Conformance Assessment, Disposition-Realization-Failure Cause, and Cause-Effect-Corrective Action—and executes declarative conformance logic over a governed knowledge graph (KG) to materialize failure causes and directed causal links while preserving traceability to evidence. An approach on solder-bridging and open-circuit scenarios using synthetic data designed is demonstrated to reflect industrial SMT data schemas and realistic value regimes. System inferences are compared against expert-validated ground-truth graphs using chain precision and recall, provenance completeness, and cycle rate. Across 30 simulated shifts of 5000 printed circuit boards (PCBs) each, the framework achieves 91.67% chain precision and 90.28% chain recall with 100% provenance completeness and no detected cycles, showing that deterministic, human-interpretable causal explanations can be generated at line scale. The resulting causal backbone yields deterministic, evidence-linked explanations that remain auditable and reusable across products and line configurations.

### 1. Introduction and Motivation

Root-cause analysis (RCA) in electronics manufacturing is increasingly difficult as product complexity, process integration, and data volume grow across multistage lines. A single printed circuit board (PCB) on a modern surface-mount technology (SMT) line can be associated with tens of process parameters per step and thousands of measurements across stencil printing, component placement, reflow, automated optical inspection (AOI), and electrical test. When a defect such as a solder bridge or open circuit is detected late, engineers must reconstruct its origin across multiple stages and tools, often using heterogeneous logs and reports; recent reviews of industrial RCA practice characterize this reconstruction as time-consuming, error-prone, and difficult to standardize. Zero-defect manufacturing (ZDM) therefore requires RCA that is systematic, repeatable, and explainable rather than ad hoc, supported by auditable decision logic and interoperable knowledge structures. In parallel, the broader smart manufacturing community has emphasized the need to link design, manufacturing, and quality artifacts into traceable digital threads using graph-based representations, providing a standards-oriented foundation for cross-domain contextualization and provenance at scale.

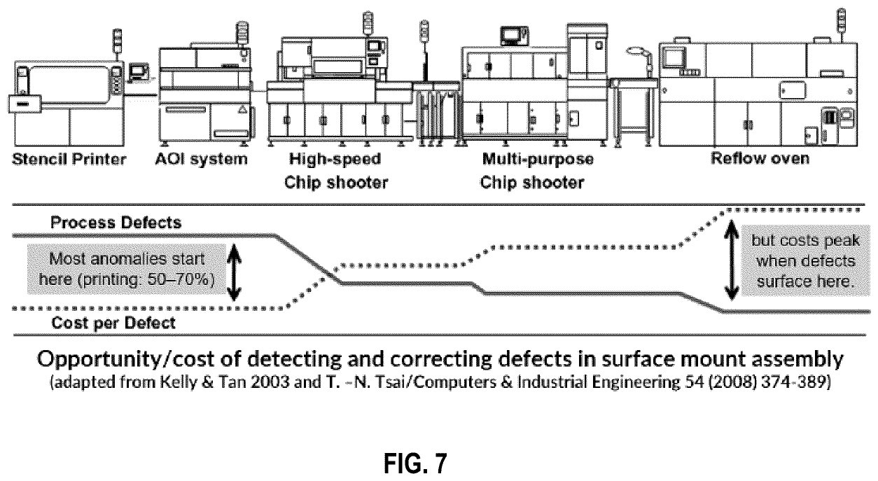

Surface-mount technology (SMT) assembly provides a concrete and industrially important instance of this challenge. In SMT, miniature electronic components are mounted on PCBs by first printing solder paste through a steel stencil that contains apertures matching pad geometries, then placing components into the paste deposits, and finally running the assembly through a reflow oven where a controlled temperature profile melts and solidifies the solder joints. Solder paste is a mixture of alloy powder and flux; its rheology, stencil design, and thermal history jointly determine whether it forms reliable joints or defects such as solder bridging and opens. A small drift in stencil thickness, aperture area ratio, paste viscosity, squeegee parameters, or reflow profile can initiate anomalies at printing or during reflow that are only detected later as defects. FIG. 7 illustrates that many defects have their origin in early steps of the line, yet are only observed after inspection or test, when containment and rework costs are high and direct evidence has decayed.

Most SMT factories already employ statistical process control (SPC), process capability indices, dashboards, and predictive alerts to monitor stencil printing, placement, and reflow behavior. These tools are effective for detecting out-of-control conditions and temporal trends, and they underpin many current ZDM initiatives. A parallel line of research applies machine learning and physics-based simulation to predict stencil-printing quality and solder-joint defects, for example through process modeling and optimization of printing parameters or through prediction of defect probabilities from printed-paste states. While these methods improve detection and local optimization, they typically operate as black-box or step-local predictors: they do not represent causal chains across multiple process stages, nor do they produce provenance-rich explanations that can be reused as formal engineering knowledge. As a result, even in advanced lines, causal explanations still depend heavily on manual expert reconstruction across heterogeneous data sources.

The following sections addresses this gap by constructing a knowledge-graph-based causal reasoning layer for SMT RCA. The central idea is to represent process specifications and observations in a shared semantic model, encode physics-based constraints as executable conformance logic over those representations, and materialize causal chains that connect parameter deviations to failure mechanisms, defects, and corrective actions. In more technical terms, the framework (i) models each specification as an information entity with lower, nominal, and upper limits; (ii) represents each observation as a measurement entity linked to the corresponding specification and process characteristic; (iii) evaluates conformance using rules derived from well-known geo-metric and thermal relationships in stencil printing and reflow (for example, area-ratio thresholds, viscosity bands, and time-temperature envelopes); and (iv) instantiates failure causes and causal relations as explicit graph edges whenever these conditions are met.

From a quality-engineering standpoint, the framework produces an instance-level “RCA packet” for each defect—a causal chain from parameter-level deviations to intermediate mechanisms and the observed defect, together with associated corrective actions and the evidence trail (measurements, specifications, and rule identifiers) used to justify each link. Practitioners can view the resulting structure as a causal knowledge graph in which conformance assessments are provenance-bearing evaluation activities that identify deviations grounded in measurable qualities of materials and processes, and causal chains are paths that can be traversed and queried. This structure enables deterministic queries such as “what were the parameter-level causes of this solder bridge on PCB17?” and “which corrective actions are associated with the earliest causes in this chain?” without requiring manual reconstruction across disparate logs.

From an engineering standpoint, the objectives are to minimize late defect propagation and to reduce diagnosis latency under realistic line variability. The technical obstacles extend beyond data semantics and include the size and heterogeneity of the data, unresolved product and panel identities across systems, and the absence of explicit causal interpretation in current predictive models. The proposed causal layer addresses these obstacles by making the specification-observation relationships explicit, by embedding physics-informed guard conditions into conformance logic, and by recording every inferred deviation and causal link with provenance. Directed cause-effect relationships form navigable chains in which upstream nodes represent mechanisms such as Aperture Overfill, Post-Print Spread, or Non-Coalescence, and leaves on the causal side represent root causes that have no immediate upstream dependencies.

The following example provides several contributions including the following:
(1) Explainable, physics-informed causal RCA for SMT quality engineering. We present a deterministic RCA method that produces human-interpretable causal chains linking specification violations and process deviations to intermediate mechanisms, defect instances, and associated corrective actions across multistage SMT assembly. Operational causal knowledge graph with provenance-by-design. We implement a governed knowledge-graph layer that integrates specifications, observations, conformance assessments, failure causes, and actions, and records end-to-end provenance for each inferred causal link to support traceability, auditability, and reuse in manufacturing quality workflows.
(2) Executable reasoning pipeline and evaluation protocol. We provide an executable rule-based reasoning pipeline that materializes conformance assessments, failure causes, and causal chains, together with an evaluation protocol based on competency-question queries and system-level metrics (chain precision/recall, cycle rate, and provenance completeness), demonstrated on solder-bridging and open-circuit scenarios.

The remaining disclosure is organized as follows. Section 2 reviews background and related work on manufacturing ontologies (including the above prior description), causal reasoning, and positions the present contributions. Section 3 presents the end-to-end causal reasoning framework at a high level. Section 3 describes the ontology design, including the specification-observation-conformance pattern, the disposition-based modeling of failure causes, and the representation of corrective actions. Section 5 consolidates rules, causal chain construction, and dynamic inferencing. Section 6 reports a case study and metrics. Sections 7 and 8 provide various non-limiting conclusions.

### 2. Background and Related Work

This section reviews prior work in three areas that are central to the subject study: (i) defect mechanisms and root-cause analysis (RCA) methods in surface-mount technology (SMT) assembly, (ii) quality engineering RCA artifacts and their formalization using ontologies and knowledge graphs, and (iii) causal reasoning and explain-able RCA approaches that motivate a provenance-aware, physics-informed causal decision-support layer for manufacturing.

### 2.1 SMT Defects and Root-Cause Analysis Methods

Defects in SMT assembly rarely originate and resolve within a single process step. A reflow excursion may surface as opens during in-circuit test; an offset in solder paste deposition may only become visible as bridging at automated optical inspection (AOI). A large body of empirical and modeling work has therefore examined how process parameters in stencil printing, placement, and reflow propagate into downstream defect modes. However, much of this literature explains propagation qualitatively or predicts defect likelihood locally, without producing instance-level, cross-stage causal chains that are directly usable as auditable RCA and corrective-action recommendations in production workflows.

Several studies identify stencil printing as a dominant initiator of downstream soldering defects. Martinek et al. investigate machine-learning techniques for predicting stencil-printing characteristics from paste rheology, stencil design, and process set-tings, and show that paste area ratio, stencil thickness, squeegee pressure and speed, and paste rheology jointly determine print quality and, by extension, the likelihood of defects later in the line. Khader and Yoon propose an adaptive optimal-control approach using reinforcement learning for squeegee parameters and demonstrate that sub-optimal printing settings continue to drive defects despite subsequent local controls. These studies emphasize that SMT is a multi-stage system in which small deviations during printing can have disproportionate effects downstream.

Mechanism-level investigations clarify why such propagation occurs. Wu and Pecht simulate solder joint formation and component tombstoning, demonstrating that imbalanced wetting forces and pad geometries during reflow lead to opens and lifts. Sidhu et al. analyze head-in-pillow (HiP) and related reflow defects, linking them to warpage, wetting dynamics, and thermal profiles. Zhao et al. quantify the impact of package warpage and board warpage on HiP formation and identify thermal and geometric conditions that push assemblies into non-wetting regimes. Tsai and Wang model and optimize stencil printing with statistical techniques, connecting aperture design and process parameters to print volume and shape. Together, these works identify physically meaningful intermediate states—local de-wetting, paste slump, warpage-induced separation—that are relevant causal nodes for RCA.

More recently, explainable-learning approaches have attempted to bridge early-stage process data and final defects. Cao et al. present XSCAN, which predicts solder-joint defect probabilities from printed-paste states and partitions the feature space into safe and high-risk regions using interpretable model features such as paste volume, brick height, and position. While such methods provide useful risk scores and saliency-like explanations, their causal semantics remain implicit in the learned models and are not directly reusable as sharable causal knowledge. More broadly, deep-learning defect detection and inspection pipelines are now well studied across manufacturing domains, yet they typically remain centered on detection/classification rather than explicit, reusable causal representation and traceable corrective-action logic. Reviews of RCA in industrial manufacturing, such as Pietsch and Kroll's scoping review, and broader ZDM surveys, highlight the need for approaches that connect process physics with formal causal representations that can be executed, audited, and operationalized for diagnosis and corrective-action decisions.

### 2.2 Human-Centered RCA Artifacts and their Formalization

In practice, RCA in manufacturing is anchored by human-centered artifacts such as Failure Mode and Effects Analysis (FMEA) tables and Ishikawa (fishbone) diagrams. IEC 60812 formalizes the FMEA procedure, terminology, and required fields, while the AIAG-VDA handbook modernizes risk prioritization by introducing an Action Priority (AP) scheme in place of raw risk-priority numbers (RPN). In electronics assembly, industry standards and process guidelines provide an additional, highly operational class of RCA artifacts. For example, IPC-S-816 organizes SMT process knowledge as observed conditions paired with commonly associated causes and suggested corrective actions across printing, placement, and reflow, and we use this structure as a standards-based source for curated failure-cause and corrective-action candidates. In addition, IPC-7527 provides solder-paste-printing acceptability criteria and troubleshooting guidance that informs printing-related failure causes and corrective actions used in our rule catalog. These standards help teams identify and document failure modes, causes, effects, and controls in a consistent structure. Ishikawa's fishbone diagrams provide a visual decomposition of potential causes under categories such as Man, Machine, Material, Method, Measurement, and Environment. They are widely used to capture expert knowledge in group settings.

Liu et al. review decades of FMEA risk evaluation methods and show that most innovations—fuzzy RPNs, multi-criteria decision-making (MCDM) hybrids, analytic network process (ANP), data envelopment analysis (DEA)—improve numerical scoring rather than the representation of causal structure itself. The knowledge remains arranged in rows and branches for human interpretation rather than being encoded in a form that machines can reason over. Interacting causes are difficult to represent; cross-stage dependencies across printing, placement, and reflow are typically implicit; and reuse is fragile, often limited to copying tables between products with manual edits.

Ontology-based approaches aim to lift this knowledge into a reusable, machine-operable form. Hodkiewicz et al. demonstrate that FMEA content can be formalized in the Web Ontology Language (OWL), enabling automated queries, classification, and consistency checks that spreadsheets cannot support. Rehman et al. go further by automatically extracting FMEA content into a domain ontology, reducing manual effort and preserving structure and terminology. Strobel proposes a Semantic Web-enabled RCA pipeline that integrates sensor data and expert knowledge into a knowledge graph, using SPARQL Protocol and RDF Query Language (SPARQL) and reasoning to support cause analysis in manufacturing. Rongen et al. integrate Resource Description Framework (RDF) semantics into the Asset Administration Shell (AAS) for Industry 4.0 and use Shapes Constraint Language (SHACL) to validate data quality at ingestion, showing that semantic constraints can play a practical role in industrial data governance.

Two complementary lines of prior work support the case for making RCA knowledge operational. First, manufacturing knowledge is frequently recorded in unstructured or semi-structured text, and ontology can provide the domain context needed to resolve manufacturing-specific ambiguities and enable reliable extraction of formal rules from such sources. Second, rule- and dependency-parsing-based information extraction methods can be used to extract structured causality representations from technical documents, reducing reliance on data-intensive training while preserving interpretability. Together, these approaches motivate scalable pathways for expanding rule catalogs and causal knowledge bases beyond manual encoding.

Ontologies have also been used as the backbone for knowledge-based decision sup-port in engineering workflows. For example, Das and Swain develop an ontology-driven decision support system for assembly variant design, using SWRL-based reasoning to infer design suggestions and their effects, illustrating the feasibility of executable knowledge models in assembly contexts even when the target task is not RCA.

ZDM-focused ontologies complement these efforts. Psarommatis, Fraile, and Ameri proposed a Zero-Defect Manufacturing Ontology (ZDMO) that organizes standardized terms and relations for defects, inspections, and improvement actions, providing a shared vocabulary across systems and stakeholders. This work demonstrates how an ontology can unify heterogeneous ZDM-related data and support integration. At the same time, its scope is primarily descriptive: causal dependencies are not yet represented as executable chains, and the ontology does not directly encode automated conformance checks or causal inference. The present inventive concept builds on this foundation by making those causal relationships explicit and operational in the context of SMT RCA.

### 2.3 Causal Reasoning, Explainable RCA, and Semantic Approaches

Theoretical foundations for causal reasoning are well established. Pearl's framework of structural causal models and directed acyclic graphs provides a way to formalize interventions and counterfactuals. For manufacturing RCA, the practical requirement is not only to represent causal structure, but also to provide evidence-linked explanations and actionable interventions that can be reviewed, audited, and updated by engineers. In manufacturing, RCA requires not only probabilistic relationships but also physically interpretable mechanisms. Model-based works such as Shi's stream-of-variation modeling for multistage manufacturing and mechanistic models of solder-joint behavior show how process dynamics can be represented, but they do not typically produce machine-executable causal chains tied directly to shop-floor data.

Razouk et al. present an AI-based knowledge-management system for RCA in the semiconductor industry that combines rule-based logic and data-driven assessment to support risk analysis and diagnosis. Their system integrates domain knowledge and operational data, but the underlying causal structures are not formulated in a shareable ontological form. Psarommatis et al. and Shi emphasize that causal models for ZDM must combine process physics, system dynamics, and quality metrics. These observations motivate approaches that encode causal knowledge in a way that is both grounded in physics and accessible to generic reasoning tools.

A complementary smart-manufacturing perspective emphasizes that effective reasoning and decision support depends on linking heterogeneous lifecycle arti-facts—requirements, models, process data, and quality reports—into traceable graph structures that can be traversed and queried across domains. This lifecycle linking perspective aligns with the role of provenance in RCA: explanations are only operationally useful when they are traceable to their evidence and contextualized within the product and process history.

Recent work further underscores the practical value of ontology for quality management under real-world constraints. Yhdego et al. propose ontology-guided strategies for federated quality control with differential privacy, using defect ontologies and controlled sharing to improve learning under small-data and privacy constraints. While their focus is additive manufacturing and privacy-preserving collaboration rather than causal-chain RCA, it reinforces the broader point that manufacturing quality knowledge is increasingly organized as structured, shareable ontological representations, creating a natural substrate for executable causal reasoning layers.

In manufacturing contexts, symbolic-neural integration is still emerging. Prudhomme et al. map the PROV Ontology (PROV-O) to formal upper-level classes and demonstrate how provenance logs can be aligned with ontological categories in a principled way. Roehl and Jansen formalize the notion of dispositions as qualities that, when realized, lead to particular process behaviors. Their work provides a useful conceptual lens for modeling tendencies such as low viscosity, excessive warpage, or marginal thermal profiles. Shenoy et al. introduce a neurosymbolic AI framework for ZDM in semiconductor assembly that combines a symbolic lane, grounded in ontologies and provenance, with a neural lane comprising convolutional, recurrent, and graph neural networks for perception and pattern discovery. One focus of the present inventive concept is specifically on the symbolic lane of that framework: it develops an ontology-based, provenance-aware causal reasoning layer for SMT RCA that can stand alone and also serve as a backbone for future neurosymbolic systems.

### 2.4 Summary of Gaps and Research Direction

The literature reviewed above shows that (i) SMT defect mechanisms and multi-stage propagation are well studied, (ii) RCA in practice is anchored by quality-engineering artifacts such as FMEA and Ishikawa diagrams, and (iii) ontologies and semantic technologies can improve consistency of terminology, integration of heterogeneous data, and some classes of reasoning. At the same time, gaps remain that limit practical, scalable RCA in production environments.

First, a persistent gap separates detection from actionable diagnosis. Many data-driven methods deliver defect predictions, risk scores, or feature attributions, but they do not produce cross-stage causal chains that connect parameter-level deviations to intermediate mechanisms, defects, and corrective actions in a form that can be directly operationalized by engineers. Second, most manufacturing and ZDM ontologies remain primarily descriptive: they support representation and integration, but do not execute physics-informed conformance assessments that instantiate causes and order them into explicit causal chains. Third, audit-grade traceability is often missing. RCA explanations are operationally useful only when they can be traced to their evidence (measurements, specifications, and decision logic) and contextualized within product and process history; without such provenance, explanations are difficult to validate, standardize, or reuse across products and lines.

These gaps motivate the approach described in the following passages. An SMT-focused causal ontology is described that internalizes curated RCA knowledge from standards, FMEA and Ishikawa artifacts, and mechanistic studies, and causal relations are made explicit and queryable at both the instance level and the domain level. Specifications, observations, and conformance assessments are represented as information entities with clear links to processes and products, enabling deterministic, physics-informed identification of deviations. Executable conformance logic converts observed violations into instantiated failure causes; causal predicates order them into navigable chains; and corrective-action specifications attach prescriptive knowledge to the most upstream defensible causes. Provenance is recorded for each conformance assessment and inferred causal link to support explainability, auditability, and continuous improvement. The resulting semantic layer is designed to be compatible with emerging ZDM ontology efforts while functioning as a practical substrate for future hybrid extensions that incorporate data-driven scoring and discovery without sacrificing semantic constraints.

### 3. Causal Reasoning Framework

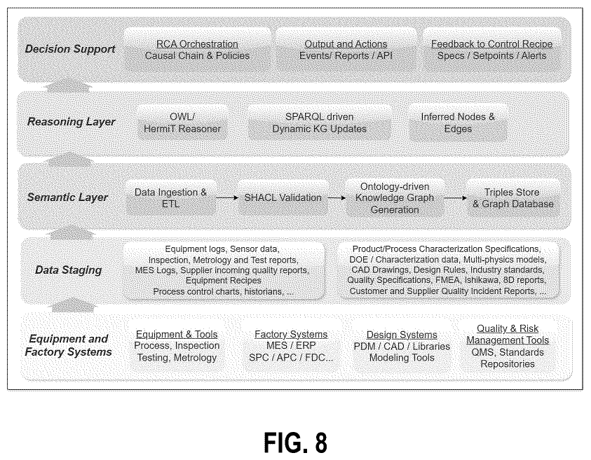

FIG. 8 summarizes the overall architecture of the proposed causal reasoning frame-work for zero-defect manufacturing (ZDM). The design addresses a central industrial challenge: factories generate large volumes of heterogeneous process and inspection data, but lack a systematic way to turn these data into explainable, evidence-based root-cause analysis (RCA) decisions. The framework connects data sources, staging and semantic integration, reasoning, and decision support into a governed knowledge graph (KG) pipeline that supports deterministic, provenance-aware RCA.

### 3.1 Equipment and Factory Systems

The bottom layer of the framework represents the operational systems that generate data relevant to SMT RCA. These include the following.
Factory systems, including manufacturing execution systems (MES), enterprise resource planning (ERP), and statistical process control (SPC) and advanced process control (APC) systems, which record lot, panel, board, and process history.
Design and engineering systems, such as computer-aided design (CAD) and product data management (PDM) libraries and design-rule repositories, which define product structures, pad geometries, and design constraints.
Quality and risk management systems, including quality management systems (QMS), reliability and field-failure systems (e.g., failure reporting, analysis, and corrective action systems (FRACAS) and returns/RMA (return material authorization) workflows), standards repositories, and incident-reporting tools, which capture Failure Mode and Effects Analysis (FMEA) tables, Ishikawa diagrams, 8D reports, corrective and preventive actions (CAPA), and corrective-action records.

These systems collectively provide the specifications, observations, causal rules, and provenance evidence that the causal reasoning framework needs. However, they differ in data models, identifiers, and temporal resolution, which motivates an explicit data-staging layer.

### 3.2 Data Staging

The data-staging layer abstracts raw feeds into a form suitable for semantic integration and reasoning. Its responsibilities include the following.
Identity alignment, where records from different systems are associated with common identifiers (lot, panel, board, pad, time stamp), enabling multi-source reasoning over a single PCB instance.
Schema normalization, including unit harmonization (e.g., mm vs. mil, percentage vs. fraction), consistent naming of parameters, and mapping of tool-specific tags to canonical fields.
Data quality handling, such as dealing with missing values, obvious outliers, and duplicate records, and capturing information about data latency and sampling rates.
Abstraction and aggregation, where high-frequency telemetry is summarized into metrics that are meaningful for RCA (e.g., per-board averages, extrema, or feature vectors for a reflow profile).

The staging layer does not enforce domain semantics, but it ensures that data entering the semantic layer are structurally coherent and sufficiently aligned for ontology-based integration.

### 3.3 Semantic Layer

The semantic layer is responsible for transforming staged data into an ontology-backed knowledge graph. It consists of four main functions, reflected in the semantic row of FIG. 8 as follows.
Data ingestion and extract-transform-load (ETL): staged records are converted into Resource Description Framework (RDF) triples according to the ontology schema defined in Section 4.
Data quality validation: the incoming triples are checked against Shapes Constraint Language (SHACL) shapes to verify structural properties and value ranges, such as required keys (e.g., board and process-step identity), unit consistency, and basic cross-field constraints. Violations are flagged and recorded as validation artifacts with provenance.
Ontology-driven KG generation: validated data are linked to ontology classes and properties, establishing relationships between specifications, observations, process steps, materials, and existing knowledge such as FMEA-derived causes.
Triple store and graph database: the resulting KG is persisted in a graph database that supports SPARQL queries and updates, providing a shared substrate for reasoning and analysis.

At this stage, the KG encodes the factual landscape: what was specified, what was observed, and how those observations relate to products and processes. The next layer adds inferential semantics.

### 3.4 Reasoning Layer

The reasoning layer performs dynamic inference over the KG. It combines rule execution with description-logic reasoning:
Rule execution: SPARQL 1.1 UPDATE templates implement physics-informed and specification-driven rules that evaluate conformance between observations and specifications. When rule conditions are satisfied, the templates insert new individuals such as conformance-assessment events and failure causes, and assert direct causal edges between deviations and defects.
   Ontology reasoning: an OWL 2 DL reasoner (HermiT) performs classification and consistency checking, derives implied type information, and computes transitive causal relations from the explicitly asserted direct links. This ensures that all inferred individuals and edges remain consistent with the ontology and that causal paths are logically well-founded.

The outcome is an extended KG in which explicit and inferred causal relationships coexist with full provenance, supporting both localized explanations (e.g., immediate causes of a defect) and higher-level analyses (e.g., recurring mechanisms across products).

### 3.5 Decision-Support Layer

The decision-support layer consumes the inferred KG to support RCA and improvement activities. It comprises three functional blocks:
RCA orchestration: orchestrates RCA workflows, selecting boards or lots of interest, executing the appropriate causal queries, and assembling causal chains that connect defects to candidate causes and mechanisms.
RCA packet and actions: presents RCA results through reports, dashboards, or application programming interfaces (APIs). Outputs include causal chains, root causes, and associated corrective actions, each with provenance to the underlying data and rules. For a solder-bridging instance, the system outputs: {PCB ID, defect, top causal chain, root causes, recommended actions, provenance links}.
Feedback to process control: selected corrective actions and updated limits can be fed back to process recipes, SPC/APC systems, or FMEA/risk registers, closing the loop between reasoning and operational control.

By structuring the pipeline in this way, the framework separates concerns: data acquisition and staging are handled at the lower layers, semantic integration and validation in the semantic layer, inference in the reasoning layer, and decision support at the top. This separation allows each layer to evolve independently while sharing a common KG.

Section 4 details the ontology that enables this framework. It formalizes the domain entities and relations used in the semantic and reasoning layers and introduces three key patterns, specification-observation-conformance assessment, disposition-realization-cause, and cause-effect-corrective action, that shape how conformance assessments, failure causes, and corrective actions are represented and inferred. Together, the framework presented here and the ontology in Section 4 provide the structural and semantic foundation for the RCA methodology developed in the remainder of the present disclosure.

### 4. Knowledge Representation and Ontology Design

The ontology design operationalizes the framework in Section 3 by providing formal classes and relations for specifications, observations, conformance assessments, dis-positions, failure causes, and corrective actions. As described herein, the ontology serves as an enabling representation that makes specifications, observations, causal mechanisms, and actions explicit and interoperable; the primary novelty is the executable causal RCA methodology and the resulting traceable decision-support outputs (causal chains and corrective actions with provenance) that can be operationalized in quality engineering workflows. The ontology follows a standards-first approach aligned with Basic Formal Ontology (BFO) and the Indus-trial Ontologies Foundry (IOF); provenance is represented using the W3C PROV Provenance Ontology (PROV-O). Causal predicates such as RO: causallyInfluences and RO: causallyInfluencedBy are reused from the Open Biological and Biomedi-cal Ontologies (OBO) Relations Ontology (RO). The resulting knowledge graph (KG) unifies factual data and inferred causal structure within a single, logically coherent representation.

### 4.1 Competency Questions and Scope

The ontology was developed around five competency questions that define its functional scope and provide testable criteria for reasoning in SMT assembly use cases. For an individual printed circuit board (PCB), the ontology should (and in some cases must) support:
CQ1: identification of the causes for a particular solder-bridging defect instance (e.g., on PCB17);
CQ2: retrieval of the corrective actions associated with that defect and its root causes;
CQ3: determination of which specification violations and parameter deviations led to the defect;
CQ4: generation of a conformance-assessment report, including provenance for the defect instance; and.
CQ5: enumeration of all modeled causes of solder bridging at the domain level, independent of a specific product instance.

These questions ensure that the ontology supports both instance-level RCA and domain-level causal knowledge.

### 4.2 Core Ontology Patterns

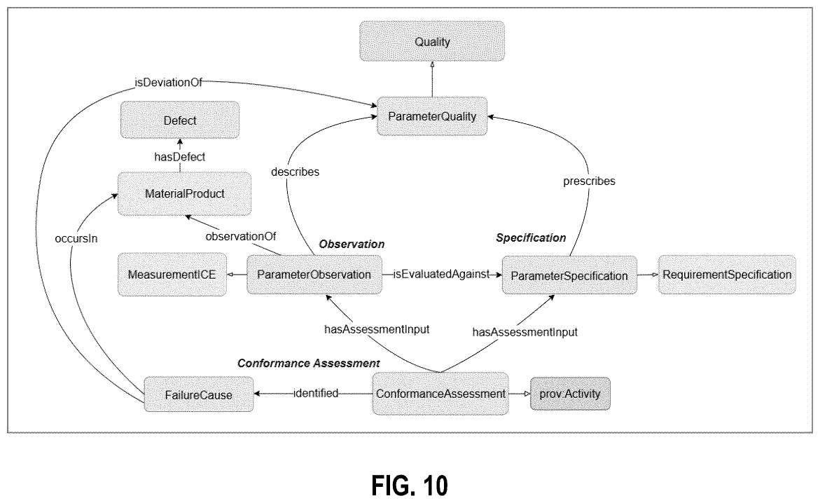

The ontology is organized around three recurring patterns that capture the life cycle from specification and observation through disposition and failure cause to causal chains and corrective actions. Together, these patterns determine how the classes and properties in Tables 1 and 2 are intended to be used in practice. FIGS. 10-13 illustrate the patterns.

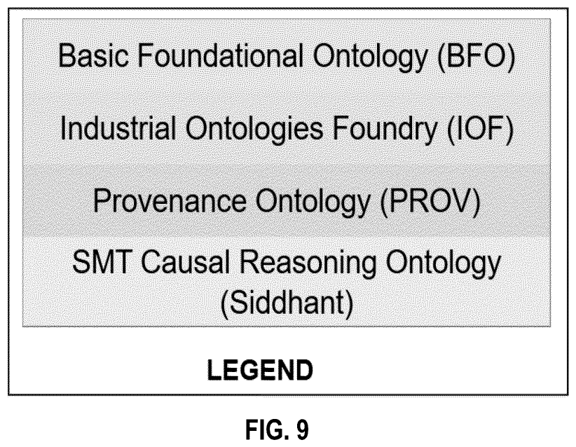

Throughout this section the namespace prefix Siddhant is used for classes and properties in the SMT Causal Reasoning Ontology. But, for readability, the prefix is omitted when it is clear from context. The name Siddhant derives from the Sanskrit term for a well-established principle or doctrine, underscoring the intent to model causal explanations that are principled, grounded, and reusable. FIG. 9 provides a legend indicating the provenance of classes in the diagrams, distinguishing entities inherited from Basic Formal Ontology (BFO), the Industrial Ontologies Foundry (IOF), and PROV-O from those introduced in the Siddhant module.

TABLE 1
Key ontology classes and axioms (Manchester syntax). Each row summarizes the informal definition, necessary
axioms, and-where provided- equivalent-class axioms used by the reasoner for classification and query.

| Class | Definition | Necessary Axioms | Necessary and Sufficient Axioms |
|---|---|---|---|
| ParameterQuality | An attribute that | subClassOf | EquivalentTo BFO: Quality and |
| | inheres in a material or | BFO: Quality | (IOF: describedBy some |
| | component (e.g., | | ParameterObservation) and |
| | thickness, viscosity, | | (IOF: prescribedBy some |
| | diameter) | | ParameterSpecification) and |
| | | | (BFO: inherseIn some |
| | | | IOF: MaterialProduct) |
| ParameterCharacteristic | Named attribute of a | subclassOf | EquivalentTo |
| | process parameter that | IOF: | IFO: ProcessCharacteristic and |
| | can be specified, | ProcessCharacteristics | and (IOF: describedBy some |
| | controlled, and | | ParameterObservation and |
| | measured. | | (IOF: prescribedBy some |
| | | | ParameterSpecification) and |
| | | | (BFO: occurentPartOf some |
| | | | IOF: ManufacturingProcess) |
| ParameterObservation | Information content | subClassOf | EquivalentTo IFO: |
| | entity capturing | MeasurementInforma- | MeasurementInforma- |
| | measured value(s) and | tionContentEntity | tionContentEntity and (IOF: |
| | unit for a specific | | describes some (ParameterQuality or |
| | parameter. | | ParameterCharacteristic)) and |
| | | | (isEvaluatedBy some |
| | | | ParameterSpecification) and |
| | | | (observationOf some |
| | | | IOF: MaterialProduct) |
| ParameterSpecification | Requirement | subClassOf | EquivalentTo IFO: |
| | specification | IOF: | RequirementSpecification |
| | constraining a | RequirementSpecifications | and (IOF: prescribes some |
| | parameter by nominal | | (ParameterQuality or |
| | value, tolerance, and | | ParameterCharacteristic)) and |
| | units | | (prov: wasDerivedFrom some |
| | | | ProductProcessSpecificationDocument) |
| Conferment | Planned evaluation of | subClassOf PROV | EquivalentTo: PROV: Activity and |
| eAssessment | observations against | Activity | (hasAssessmentInput some |
| | physics-based rules | | IOF: InformationContentEntity) |
| | and specifications. | | and (identified some |
| | | | FailureCuase) |
| FailureCause | A specifically | subClassOf BFO: | EquivalentTo: BFO: |
| | dependent continuant | SpecificallyDependantContinuant | SpecificallyDependantContinuants |
| | which is deviation of | | and affects some |
| | ParameterQuality or | | IOF: MaterialProduct) and |
| | ParameterCharacteristic | | (prov: wasGeneratedBy some |
| | and serves as the | | ConformanceAssessment) and |
| | causal basis for a | | (directlyCausallyInfluences some |
| | disposition. | | Defect or FailureCause) |
| ProcessFailureCause | FailureCause whose | subclassOf | |
| | primary basis is | FailureCause and | |
| | deviations in process | (isDeviationOf only | |
| | execution | ParameterCharacteristic) | |
| | characteristics. | | |
| ProcessFailureCause | FailureCause whose | subclassOfFailureCause | |
| | primary basis is | and | |
| | material, | (isDeviationOfonly | |
| | environmental, or | ParameterQuality) | |
| | equipment-related | | |
| | qualities. | | |
| Defect | A specifically | subClassOf BFO: | EquivalentTo: BFO: |
| | dependent continuant | SpecificallyDependentContinuant | SpecificallyDependantContinuant |
| | that inheres in a | | and (defectOccursOn |
| | material product (e.g. | | some IOF: Material Product) |
| | PCB) and represents | | |
| | an undesired structural | | |
| | or functional deviation. | | |
| CorrectiveActionSpec- | Recommended action | subClassOf | EquivalentTo: |
| ification | specification intended | IOF: ActionSpecification | IOF: ActionSpecification and |
| | to eliminate or mitigate | | (corrects some RootCause) |
| | one or more root | | |
| | causes. | | |
| EffectDisposition | A disposition that | subClassOf | EquivalentTo: BFO: Disposition |
| | inheres in a material | IOF: Disposition | and (BFO: inheresIn some |
| | entity and that given | | IOF: MaterialEntity) and |
| | an appropriate | | (hasRealizationTrigger) and |
| | manufacturing trigger, | | (hasParticipant some |
| | is realized in a defect- | | IOF: MaterialEntity) |
| | producing process. | | |
| EffectRealization | A process that is the | subClassOf | EquivalentTo: BFO: Process and |
| | realization of a | BFO: Process | (realizationOf some Disposition) |
| | disposition and in | | and (hasTrigger some |
| | which the bearer | | EffectRealizationTrigger) and |
| | material entity | | (hasParticipant some |
| | participates, leading to | | IOF: Material Entity) |
| | or contributing to a | | |
| | failure cause or a | | |
| | defect. | | |
| EffectRealizationTrigger | A manufacturing | subclassOf | EquivalentTo: |
| | process that can serve | IOF: ManufacturingProcess | IOF: ManufacturingProcess and |
| | as the trigger for the | | (Triggers some |
| | realization of a | | EffectRealization) |
| | disposition. | | |

### 4.2.1. Specification-Observation-Conformance Assessment

Pattern (P1) describes how parameter qualities, their specifications, and corresponding observations are represented and related. As summarized in Table 1, ParameterQuality is a subclass of BFO: Quality that inheres in a MaterialProduct (for example, stencil thickness, paste viscosity, or board planarity).

TABLE 2
Object properties and logical characteristics. The catalog lists parent relations, inverses, and domain/range constraints
for deviation, causal, conformance, disposition, trigger, and provenance links in the Siddhant ontology.

| Object | | | |
|---|---|---|---|
| Property | Parent | Inverse Of | Domain |
| hasDeviation | None | isDeviationOf | BFO: Qualityor |
| | | | IFO: ProcessCharacteristic |
| hasDefect | BFO: bearerOf | defectOccursOn | PCB (Product) |
| defectOccursOn | BFO: inheresIn | hasDefect | Defect |
| hasObservation | IOF: describedBy | observationOf | PCB |
| observationOf | IOF: describes | hasObservation | IOF: MeasurementICE |
| hasAssessmentInput | PROV: used | isAssessmentInputFor | ConformanceAssessment |
| isCorrectedBy | None | Corrects | FailureCause |
| hasBase | None | isBaseOf | BFO: Disposition |
| hasRealization | None | realizationFor | BFO: Disposition |
| directlyCausallyInfluencedBy | RO: causallyInfluencedBy | directlyCausallyInfluences | Effect |
| wasIdentifiedBy | None | Identified | FailureCause |
| isEvaluatedAgainst | IOF: isAbout | Evaluates | ParameterObservation |
| resultsIn | IOF: hasOutput | resultsFrom | EffectRealization |
| triggeredBy | IOF: hasOutput | Triggers | EffectRealization |
| IOF: describes | — | IOF: describedBy | IOF: MeasurementICE |
| IOF: prescribes | — | IOF: prescribedBy | IOF: RequirementSpecification |
| BFO: inheresIn | — | BFO: bearerOf | BFO: Quality |
| IOF: occurrentPartOf | BFO: part of | IOF: hasOccurrentPart | IOF: ProcessCharacteristic |

| Object | | | Inverse |
|---|---|---|---|
| Property | Range | Functional | Functional |
| hasDeviation | FailureCause | | ✓ |
| hasDefect | Defect | ✓ | ✓ |
| defectOccursOn | PCB | | ✓ |
| hasObservation | IOF: MeasurementICE | ✓ | ✓ |
| observationOf | PCB | ✓ | |
| hasAssessmentInput | IOF: ICE | | |
| isCorrectedBy | CorrectiveAction | | |
| hasBase | Entity | | |
| hasRealization | ConformaceAssessment | | |
| directlyCausallyInfluencedBy | FailureCause | | |
| wasIdentifiedBy | ConformanceAssesment | ✓ | ✓ |
| isEvaluatedAgainst | ParameterSpecification | | |
| resultsIn | Defect or FailureCause | | |
| triggeredBy | Defect or FailureCause | | |
| IOF: describes | IOF: ProcessCharacteristic, | | |
| | BFO: Quality | | |
| IOF: prescribes | IOF: ProcessCharateristic, | | |
| | BFO: Quality | | |
| BFO: inheresIn | BFO: MaterialEntity | | |
| IOF: occurrentPartOf | BFO: Process | | |

A quality is constrained by a ParameterSpecification, an IOF RequirementSpecification that records nominal values and tolerance limits. Measurements of that quality are captured as ParameterObservation instances, which are information-content entities linked to the measured product via observationOf and to the governing specification via isEvaluatedAgainst (Table 2).

A ConformanceAssessment is modeled as a prov: Activity that consumes one or more specification-observation pairs through hasAssessmentInput. Domain rules (Section 5) are applied in the assessment to classify observations as conforming or deviating; deviations are later interpreted as failure causes in Pattern (P2). If a quality is outside its prescribed range, the corresponding FailureCause can be linked back to the quality by hasDeviation/isDeviationOf. FIG. 10 shows the resulting structure.

In ontological terms, Pattern (P1) provides the information layer on which the rest of the reasoning is built: it makes explicit what was specified, what was measured, for which product, and with respect to which requirements.

### 4.2.2 (P2) Disposition-Realization-FailureCause

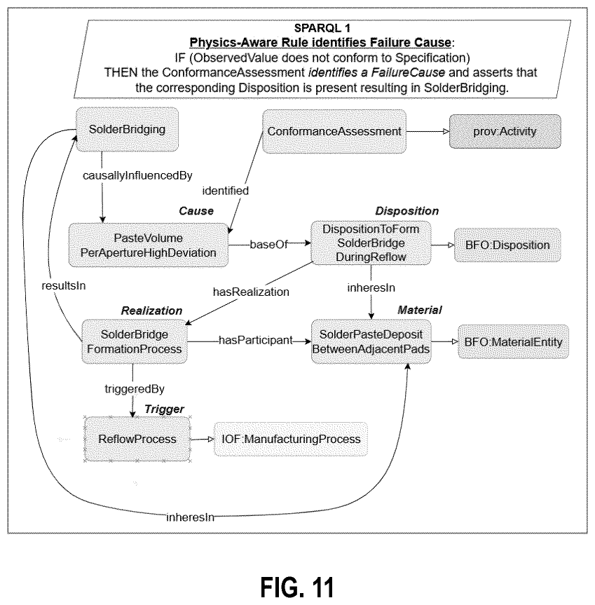

Pattern (P2) refines the causal semantics of an SMT mechanism by explicitly separating (i) an underlying disposition that inheres in a material bearer, (ii) the realization process through which that disposition manifests under a triggering manufacturing process, and (iii) the FailureCause individual that records the identified deviation as a first-class, queryable node in the causal graph (FIG. 11). In Siddhant, the intent is to model causes in a way that is faithful to BFO's disposition-realization account while remaining operational for rule-based RCA.

Three key classes structure this pattern (Table 1). EffectDisposition is a subclass of BFO: Disposition that inheresIn a material bearer (e.g., a solder paste deposit between adjacent pads). The disposition is grounded in measurable physical state through its base, expressed via hasBase (with inverse isBaseOf), which links the dis-position to the relevant ParameterQuality (e.g., excessive paste volume per aperture, low viscosity) that provides the physical basis for the tendency. EffectRealization is a subclass of BFO: Process representing the mechanism-specific process in which the disposition is realized (e.g., a solder-bridge formation process). FailureCause is modeled as a specifically dependent continuant that serves as the causal node recorded and propagated by the reasoning layer; it is the object that downstream causal relations and corrective-action associations operate on in Pattern (P3).

The core object properties that connect these classes are summarized in Table 2. The disposition is connected to its realizing process using hasRealization (inverse realizationOf). The realization is anchored to the manufacturing context using triggeredBy, whose range is an IOF: ManufacturingProcess (e.g., a reflow process) that provides the triggering conditions under which the disposition can manifest. Participation is made explicit using hasParticipant, linking the EffectRealization to the same material entity in which the disposition inheres, thereby preserving a coherent bearer-process account: the bearer carries the disposition, participates in the realization, and is the locus at which the mechanism unfolds.

A critical modeling choice in Siddhant is that ConformanceAssessment (Pat-tern (P1)) is treated as a provenance-bearing identification activity rather than as the generator of the underlying disposition or realization. Conformance assessments are modeled as prov: Activity instances that consume specification-observation evidence and wasIdentifiedBy a FailureCause when nonconformance is detected. In other words, the assessment records and makes explicit—in a queryable, auditable form—the failure cause that corresponds to an already-realized (or realizable) disposition under the given manufacturing trigger. This separation ensures that the ontology can represent both (i) the physical semantics of mechanism manifestation (disposition and realization) and (ii) the epistemic act of diagnosing a cause from data and rules (conformance assessment with provenance), without conflating the two.

FIG. 11 illustrates the pattern for solder-bridge formation, but the same structure applies to warpage-driven, wetting, and other SMT mechanisms: a disposition inheres in a material bearer, is triggered by a manufacturing process, is realized in a mechanism-specific process, and a corresponding FailureCause is identified by a conformance assessment for use in causal chaining and downstream decision support.

### 4.2.3 (P3) Cause-Effect-Corrective Action

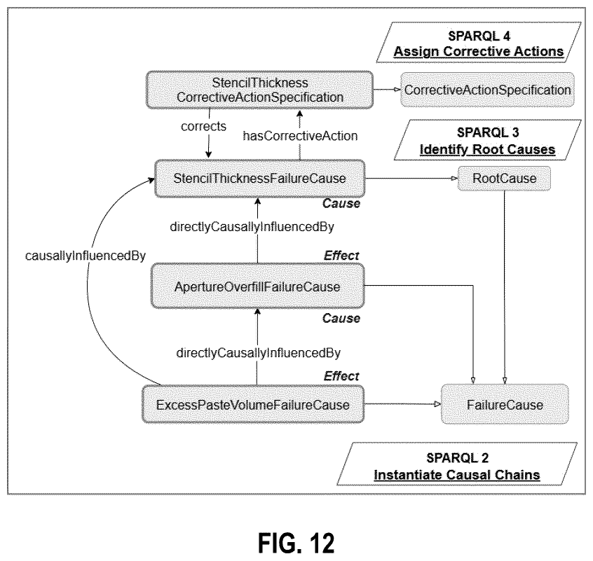

Pattern (P3) organizes failure causes, defects, and actions into explicit causal chains (FIG. 12). Here, FailureCause and Defect play the role of nodes in a graph whose edges are RO causal predicates. Immediate links are asserted using RO: directlyCausallyInfluencedBy between an effect and its closest upstream cause; the transitive superproperty RO: causallyInfluencedBy is derived by the reasoner, yielding multi-step paths.

Within this graph, a RootCause is defined (Table 1) as a FailureCause that has no incoming directlyCausallyInfluencedBy edges in the defect-specific subgraph. This matches the intuitive notion of a most-upstream cause for a given defect. CorrectiveActionSpecification specializes IOF: ActionSpecification and is linked to root causes via corrects (and its inverse isCorrectedBy), capturing recommended interventions such as modifying stencil thickness or adjusting reflow profiles.

Ontologically, Pattern (P3) ties together the outputs of Patterns (P1) and (P2): conformance assessments and realized dispositions determine which FailureCause instances exist; RO predicates order them into causal chains; and action specifications attach prescriptive knowledge to the most upstream causes. These three patterns collectively provide the semantic backbone that the dynamic inferencing layer in Section 5 uses to construct, analyze, and explain causal chains for SMT root-cause analysis.

### 5. Methodology: Rules, Causal Chains, and Dynamic Inferencing

The methodology translates the ontology patterns in Section 4 into executable reasoning. It uses physics-based rules to evaluate process data against specifications and SPARQL 1.1 queries to instantiate and connect individuals in the knowledge graph (KG). The resulting workflow links specification violations to failure causes, defects, and corrective actions, and records the evidential trail for each step.

### KG Generation:

In all experiments, the starting point for reasoning is a staged tabular dataset in which each row corresponds to a PCB and each column records a process parameter or identifier (Section 6). During ETL, these records are converted into RDF triples according to the ontology schema: every PCB row gives rise to a MaterialProduct individual; specification tables (e.g., Table 3) are instantiated as ParameterSpecification individuals with nominal and limit values; and each measured entry in the process data becomes a ParameterObservation linked to the PCB via observationOf and to its governing specification via isEvaluatedAgainst (Pattern (P1)). The result is a factual knowledge graph that records “what was specified” and “what was observed” for each board independent of any inference. The rule library and SPARQL templates described below operate on this graph to add conformance assessments, failure causes, and causal edges, which are subsequently queried in the competency-question experiments.

### 5.1 Physics-Based Rules for Failure-Cause Identification

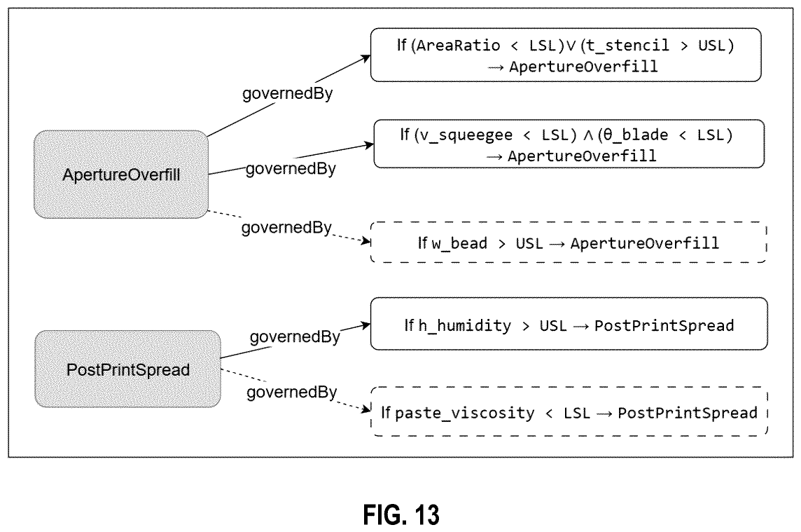

The starting point for the reasoning layer is a library of physics-based rules that encode SMT process knowledge. Each rule compares one or more measured parameters to their specifications and, when a violation is detected, classifies the event under an appropriate FailureCause. The rules are drawn from stencil-printing and reflow physics—for example, geometric constraints on aperture area ratio, limits on stencil thickness, and viscosity ranges for acceptable paste transfer. FIG. 13 summarizes representative rules for the ApertureOverfill and PostPrintSpread mechanisms.

A key geometric quantity in stencil printing is the aperture area ratio. For a rectangular stencil aperture with width w, length l, and stencil thickness t_{stencil}, the area ratio is

$$AreaRatio = \frac{{A}_{opening}}{{A}_{wall}} = \frac{wl}{2 ( w + l ) {t}_{stencil}} . \qquad ( 1 )$$

Stencil design standards such as IPC-7525A/B recommend an area ratio greater than 0.66 to achieve reliable paste release and transfer efficiency; smaller ratios lead to incomplete or unstable deposits, especially when the stencil is relatively thick. In practice, both area ratio and absolute stencil thickness influence how much sol-der paste is delivered to the pads. Too low an area ratio or too thick a stencil can leave excessive paste in the aperture, increasing the chance of ApertureOverfill and, downstream, solder bridging.

The updated rule in FIG. 13 reflects this combined dependency and can be expressed as:
If (AreaRatio<LSL) or (StencilThickness>USL), then assert the failure cause ApertureOverfill.

A second rule captures kinematic effects:
If (squeegee speed<LSL) and (squeegee blade angle<LSL), then assert ApertureOverfill.

Together, these rules state that ApertureOverfill can arise either from unfavorable aperture geometry and thickness or from poor squeegee dynamics. Additional rules for the PostPrintSpread mechanism encode process-chemistry interactions; for example:
If ambient humidity>USL, then assert HighHumidityFailureCause.
If paste viscosity<LSL, then assert LowViscosityFailureCause.

In all cases the rules are deterministic and interpretable. They consume specification-observation pairs from Pattern (P1) and instantiate well-typed FailureCause instances that participate in the disposition-realization pattern of Pattern (P2), making the “physics-aware” nature of the reasoning explicit rather than implicit.

### 5.2 SPARQL-Based Rule Execution and Causal Chain Assembly

Domain rules are realized as SPARQL 1.1 UPDATE/CONSTRUCT templates. Starting from staged data and the ontology patterns in Section 4.2, these templates extend the knowledge graph by creating conformance assessments, failure causes, and causal links.

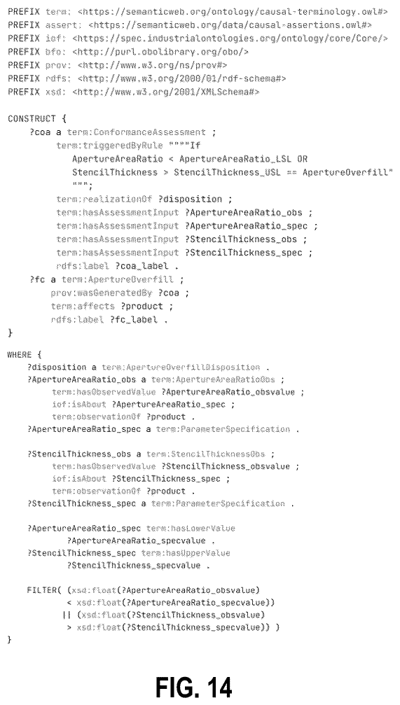

FIG. 14 shows the template that implements the combined aperture-area-ratio/stencil-thickness rule. The PREFIX declarations bind the namespaces for the Siddhant ontology, IOF, BFO, PROV, and RDF Schema. In the CONSTRUCT block, the template creates:
a ConformanceAssessment individual ?coa, annotated with a term: triggeredByRule string and linked to the relevant observations and specifications via term: hasAssessmentInput;
a FailureCause individual ?fc of type term: ApertureOverfill, linked to the assessment by prov: wasGeneratedBy, to the affected product via term: affects, and to the governing disposition via term: realizationOf.

The WHERE clause matches two specification—observation pairs: an ApertureArea-RatioObs with its ParameterSpecification, and a StencilThicknessObs with its specification. The physics-aware condition is encoded in a single FILTER expression:

```
FILTER(
    xsd:float(?ApertureAreaRatio_obsvalue)
      < xsd:float(?ApertureAreaRatio_specvalue)
    ||
    xsd:float(?StencilThickness_ob
    svalue)
      > xsd:float(?StencilThickness_specvalue)
  )
```

Thus the assessment and ApertureOverfill failure cause are materialized whenever either the area ratio falls below its LSL or the stencil thickness exceeds its USL. The same template structure is reused for other rules by changing the classes, predicates, and conditions while preserving the links required by Patterns (P1)-(P3).

More generally, the rule-execution pipeline proceeds as follows:
Initialization. Staged records create individuals for ParameterSpecification, ParameterObservation, and related process and material entities, as described in Section 3.
SPARQL 1: Conformance evaluation. Templates of the form in FIG. 14 evaluate physics-based conditions over specification-observation pairs and, when violated, construct conformance assessments and failure causes with full provenance.
SPARQL 2 and SPARQL 3: Causal linking and root-cause designation. Additional templates assert direct causal edges using RO: directlyCausallyInfluencedBy, derive transitive RO: causallyInfluencedBy relations, and retype most-upstream failure causes as RootCause.
SPARQL 4: Corrective-action association. Corrective-action specifications are attached to root causes via corrects/isCorrectedBy, using intervention labels and troubleshooting guidance curated from standards-based artifacts (e.g., IPC-S-816 and IPC-7527) and other quality documents such as FMEA and 8D reports.

Together, these templates form a deterministic pipeline: physics rules plus SPARQL templates identify deviations, classify them as failure causes, organize them into causal chains, and bind corrective actions, yielding a knowledge graph that supports both diagnostic and predictive RCA queries.

### Scalability and Generalization

Because the rules are expressed as SPARQL templates over ontology terms, domain experts can extend the rule library by adding new templates or adjusting thresholds without modifying the underlying schema. This design explicitly supports practical rule maintenance by manufacturing and quality engineers: rules can be reviewed, versioned, and updated as process windows, materials, and equipment change, without requiring modification of the underlying ontology schema or application code. The same mechanism generalizes to other defect modes, such as opens, voids, or wetting failures, and to additional processes beyond stencil printing and reflow.

The methodology described above provides a deterministic and transparent mechanism for causal inference in SMT assembly. The next section applies this pipeline to two representative defect mechanisms, solder bridging and open circuits, and evaluates how well the inferred causal chains match expert ground truth and support the competency questions defined in Section 4.

### 6. Case Study: Physics-Aware Causal Chains for Solder Bridging and Opens

This section demonstrates the application of the ontology and reasoning methodology to representative defect scenarios in SMT assembly, namely solder bridging and open circuits. We first describe the data format and synthetic factory used for evaluation, then discuss how the competency questions are answered, and finally report performance metrics and interpretation.

### 6.1 Data and Setup

We began by sampling real SMT factory data from a production environment and working with process experts to understand the structure, parameter ranges, and typical value distributions used in practice. Based on this analysis, we implemented a synthetic factory generator that produces data with the same schema and simi-lar value regimes, but under controlled conditions and without exposing proprietary information.

Each record in the dataset corresponds to one printed circuit board (PCB) and contains:
identifiers and lot metadata (lot id, panel id, PCB ID, pad identifiers);
printing parameters, including stencil thickness, aperture diameter, paste volume per aperture, paste roll bead size, residual paste, squeegee pressure, squeegee speed, squeegee angle, aperture area ratio, paste viscosity, ambient relative humidity, and metal load; and
reflow parameters, including peak reflow temperature, time above liquidus (TAL), and board thermal gradient.

Table 3 summarizes the principal process parameters, their nominal values, and the specification windows used in conformance assessment. These names and units match the columns in the synthetic dataset and illustrate the format of the parameter fields.

Parameter values for each simulated PCB are generated by Monte Carlo sampling from univariate Gaussian distributions centered at the nominal specification values. For each parameter, the standard deviation is chosen as a fixed fraction of the specification span so that most samples fall within the tolerance window and a small proportion fall just outside it. This yields light-tailed variability around engineering targets, emulating realistic process scatter while preserving a clear distinction between in-spec and out-of-spec behavior. In the current work, parameters are sampled independently, without an explicit correlation structure between them (for example between squeegee pressure and squeegee speed). This independence assumption keeps the testbed analytically transparent. Future extensions can introduce physics-informed correlation schemas and time-series behaviors, including drift scenarios and stage-to-stage dependencies, guided by measured autocorrelation and cross-correlation in factory data and by discrete-event models of the SMT line.

For each PCB, the specification limits in Table 3 can be used together with the physics-based rules in Section 5 to evaluate conformance, identify deviations and failure causes, assign defect labels (solder bridge or open), and attach corrective-action labels.

TABLE 3
Abbreviated specification set (nominal and
limits) used in conformance assessment.

| Parameter | Nominal | | Limits/Tolerance | |
|---|---|---|---|---|
| Stencil thickness | 0.100 | mm | ±0.005 | mm |
| Aperture diameter | 0.340 | mm | ±0.020 | mm |
| Paste volume/aperture | 0.040 | mm³ | ±0.004 | mm³ |
| Paste roll bead size | 4.0 | mm³ | ±0.4 | mm³ |
| Residual paste | 5.0% | vol. | ±0.5% | |
| Squeegee pressure | 0.30 | MPa | ±0.03 | MPa |
| Squeegee speed | 70 | mm/s | ±14 | mm/s |

| | | |
|---|---|---|
| Squeegee angle | 60° | ±5° |
| Aperture area ratio | ≥0.66 | (lower bound) |

| | | | | |
|---|---|---|---|---|
| Paste viscosity (25° C.) | 200 | Pa · s | ±50 | Pa · s |
| Peak reflow temperature | 255° | C. | ±5° | C. |
| Time above liquidus (TAL) | 60 | s | ±15 | s |

| | | |
|---|---|---|
| Ambient relative humidity | 40% | ±10% |

| | | | | |
|---|---|---|---|---|
| Metal load (paste) | 80 | wt % | ±10 | wt % |

The resulting dataset therefore has one row per PCB and columns for all process parameters, conformance outcomes, mechanisms, root causes, defects, and actions. While the present synthetic generator is intentionally simple, it is constructed to be consistent with observed SMT data formats and ranges, and it provides a controlled substrate on which more sophisticated, correlation-aware generative models can be layered in future implementations.

For qualitative illustration, a 50-PCB subset was used in which PCB17 exhibits a solder-bridging defect with a rich causal chain. For quantitative evaluation, the synthetic factory is run for 30 independent shifts, each simulating 5000 PCBs. The metrics reported in Section 6 are averages over these 30 runs.

### 6.2 Results for Competency Questions (CQ1-CQ5)

The five competency questions defined in Section 4 were evaluated to test the ontology's coverage and reasoning capability. Each competency question (CQ) is implemented as a SPARQL query over the inferred knowledge graph. We illustrate the approach in detail for CQ1 and then summarize the remaining questions.

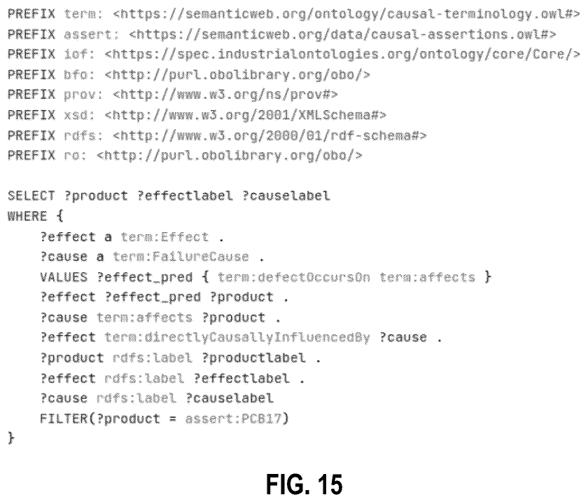

FIG. 15 shows the SPARQL query used to answer CQ1 for PCB17. The query retrieves all immediate cause-effect pairs for a given product:
It selects ?effect and ?cause individuals typed as term: Effect and term: FailureCause, respectively.
The VALUES clause binds ?effect pred to either term: defectOccursOn or term: affects, so that both defects and intermediate failure causes can be associated with the same product ?product.
The triple pattern ?effect term: directlyCausallyInfluencedBy ?cause restricts the result to immediate causal links, relying on the ontology pattern from Section 4.
Labels for the product, effect, and cause are obtained via rdfs: label, and a FILTER limits the query to a specific PCB (assert: PCB17 in this example).

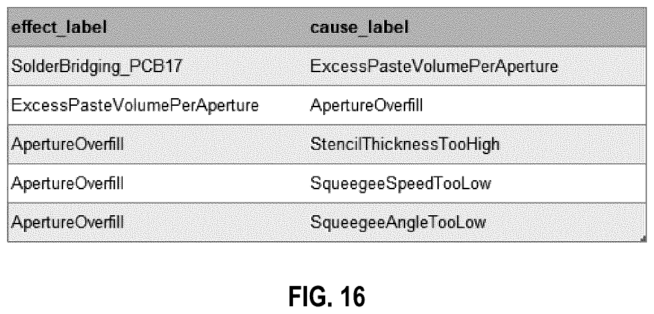

The tabular output of this query is shown in FIG. 16. Each row lists an effect label and its immediate cause label for PCB17. The top row states that SolderBridging PCB17 is directly caused by ExcessPaste VolumePerAperture; subse-quent rows show that ExcessPaste VolumePerAperture is caused by ApertureOverfill, which in turn is caused by the parameter-level deviations StencilThicknessTooHigh, SqueegeeSpeedTooLow, and SqueegeeAngleTooLow.

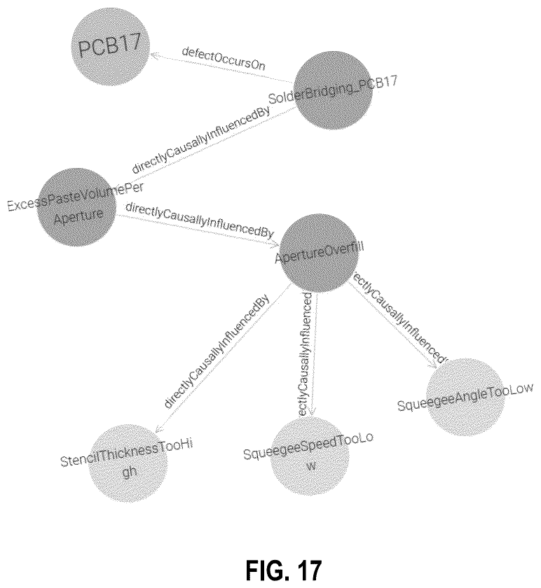

The same information can be visualized as a causal tree, shown in FIG. 17. A blue node represents the solder-bridging defect, red nodes represent mechanisms, and yellow nodes represent parameter-level causes. Directed edges correspond to RO: directlyCausallyInfluencedBy relations.

### CQ2-CQ4—Additional Queries.

The remaining competency questions use similar SPARQL patterns:
CQ2—Corrective actions. This query retrieves corrective actions attached to root causes, such as “use thinner foil or step-down; reduce aperture size” for StencilThicknessTooHigh and “raise speed into window; balance with pressure and angle” for Squeegee SpeedTooLow.
CQ3—Specification violations. The query lists violated specifications and observed values for a given PCB, confirming, for PCB17, that stencil thickness exceeded its upper limit, squeegee speed fell below its lower limit, and squeegee angle was flatter than the prescribed window.
CQ4—Conformance-assessment provenance. This query returns the ConformanceAssessment activities that identified each failure cause, together with the Measurement ICEs and ParameterSpecification instances used and the rule identifiers that were applied, thereby satisfying traceability requirements.

### CQ5—Domain-Level Causal Knowledge for Solder Bridging.

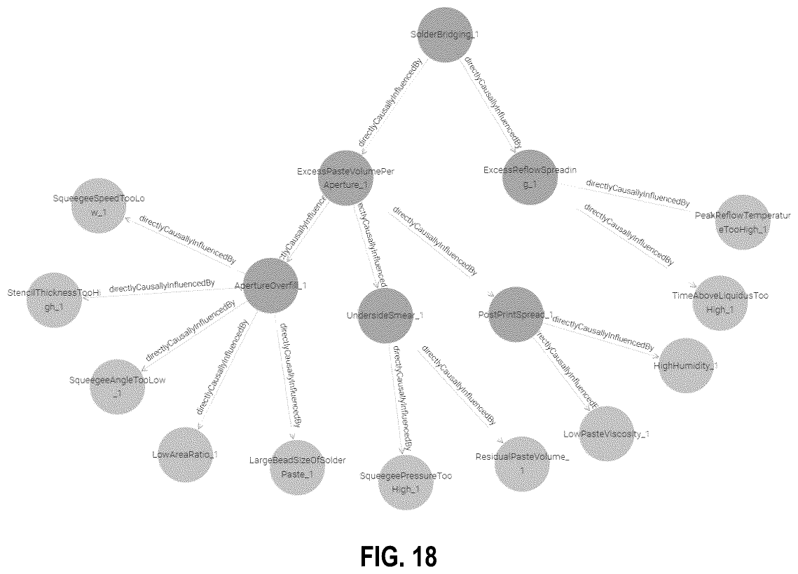

While CQ1-CQ4 focus on a single product instance, CQ5 asks for all modeled causes of solder bridging across the dataset. The corresponding SPARQL query aggregates causal knowledge at the class level, returning distinct pairs of cause and effect types involved in chains that terminate in a solder-bridging defect. The result is summarized in FIG. 18, which shows the domain-level causal network for solder bridging.

Together, CQ1-CQ5 demonstrate that the ontology and reasoning layer support both instance-level RCA and the domain-level causal knowledge using a uniform SPARQL interface over the causal knowledge graph.

### 6.3 Interpretation and Human-In-the-Loop Feedback

Expert input played an important role in shaping the rule catalog and establishing the domain-consistent ground-truth causal chains used in this study. Several practitioners with experience across SMT manufacturing, quality systems, workflow design, and EMS production environments contributed to this process.

Their feedback informed the development of the physics-aware rules, clarified how causal mechanisms manifest in practical settings, and supported the creation of representative ground-truth chains for qualitative validation. After the reasoning layer was implemented, these experts reviewed the system-generated causal chains for the evaluation set, confirming the plausibility of the inferred mechanisms and suggesting refinements where domain practice indicated additional causal relationships.

This iterative, human-in-the-loop process helped ensure that the symbolic reasoning layer remained aligned with real manufacturing practice while preserving the transparency, determinism, and auditability of the ontology-based framework.

In most cases the inferred causal chains and intermediate mechanisms aligned with expert judgment: over 30 runs of 5000 PCBs each, chain-level agreement reached 91.67% precision and 90.28% recall, with no cycles detected (Table 4) In a few cases, expert review suggested additional causal relations that were not encoded in the original rule base, for example, a link from HighPasteRollBeadSize to ApertureOverfill. This evaluation underscores the value of a human-in-the-loop process: the symbolic model provides a transparent substrate in which each inferred link is explicit, and expert validation can be used to refine rules, extend the ontology, and correct omissions. Because the experts reviewed the generated chains post hoc, the exercise primarily validates the behavior of the reasoning layer and its knowledge representation, rather than merely confirming that expert rules were transcribed as intended.

### 6.4 System Metrics and Performance

Quantitative evaluation uses four system-level metrics designed to assess both the completeness of provenance and the structural quality of the inferred causal chains. All metrics are computed over the set of defective printed circuit boards (PCBs) unless otherwise noted. Chain precision and recall serve as proxies for diagnosis accuracy; provenance completeness supports auditability and traceability in quality management; and cycle rate supports structural validity by indicating whether the inferred causal model contains spurious feedback loops.

Let E_{sys}(i) and Eₑₓₚ(i) denote the sets of causal edges in the system-inferred and expert-annotated graphs, respectively, for defective PCB i, and let N_{def} denote the number of defective PCBs in the dataset. Each causal edge is an ordered pair<c_{cause}, c_{effect}> connected by RO: directlyCausallyInfluencedBy.

### Provenance Completeness.

Provenance completeness quantifies the extent to which inferred failure causes and corrective actions are accompanied by complete provenance trails. For each inferred failure-cause or corrective-action individual, we check whether there exist: (i) at least one linked ConformanceAssessment activity, (ii) the corresponding MeasurementICE individuals, and (iii) the RuleICE instances that support the assessment. Provenance completeness is the fraction of all inferred failure causes and corrective actions that satisfy these conditions.

### Cycle Rate.

Cycle rate reports whether any directed cycles are present in the causal graph for each defective PCB, where edges are induced by the ontology's immediate-causation relation (RO: directlyCausallyInfluencedBy). A low cycle rate indicates that the rule configuration and causal modeling are structurally sound and do not introduce spurious feedback loops. In our experiments we report whether any cycles are detected in any of the evaluated runs.

### Chain Recall and Chain Precision.

To evaluate the fidelity of inferred causal chains, we compare the system and expert graphs edge by edge. Chain recall and chain precision are defined as:

$$Recall = \frac{{\sum }_{i = 1}^{{N}_{def}} \vert {E}_{sys} ( i ) ⋂ {E}_{exp} ( i ) \vert}{{\sum }_{i = 1}^{{N}_{def}} \vert {E}_{exp} ( i ) \vert} , \qquad ( 2 )$$

$$Precision = \frac{{\sum }_{i = 1}^{{N}_{def}} \vert {E}_{sys} ( i ) ⋂ {E}_{exp} ( i ) \vert}{{\sum }_{i = 1}^{{N}_{def}} \vert {E}_{sys} ( i ) \vert} .$$

These metrics focus on the recovery of expert causal edges for defective boards only; non-defective boards, for which both edge sets are empty, are excluded to avoid artificially inflating scores with trivial matches.

### Quantitative Results.

Using the synthetic factory described in Section 6, data was generated for 30 independent shifts, each simulating 5000 PCBs, and the full reasoning pipeline was applied to each run. Under the perturbed configuration described below, the current configuration of the RCA system achieves provenance completeness of 100%, confirming that every inferred failure cause and corrective action carries complete provenance. Chain recall (90.28%) and chain precision (91.67%) show that the vast majority of expert causal edges are recovered, with relatively few spurious links introduced, and no cycles were detected in any run. Table 4 reports the averages of these four metrics over the 30 runs.

### Calibration and Perturbed Rule Configurations.

To understand how different error modes affect the causal-chain metrics, we evaluated the system under three rule configurations. In the calibration regime, the same physics-based and specification-driven rules powered both (i) the ground-truth causal-chain generator and (ii) the knowledge-graph inference engine. With this alignment, all causal-chain metrics that depend on the causal structure (precision and recall) are, by construction, 100%, providing a clean baseline against which to study error modes. We use this calibration regime only as a controlled reference condition to isolate how specific rule mismatches drive false-negative and false-positive causal edges before transitioning to field validation.

TABLE 4
System-level metrics for causal reasoning performance
(averaged over 30 runs of 5000 PCBs each).

| Metric | Result |
|---|---|
| Provenance completeness | 100% |
| Cycle rate | No cycles detected Chain |
| recall | 90.28% |
| Chain precision | 91.67% |

To probe false-negative behavior, we introduced two additional physics rules only into the ground-truth rule set:
paste roll bead size>USL→aperture overfill, and
paste viscosity<LSL→post-print spread.

For boards whose measurements violate these conditions, the ground-truth generator now asserts additional causal edges. Because the knowledge graph does not contain these rules, it systematically misses these links, selectively reducing chain recall while leaving precision relatively less affected.

Finally, to study false-positive behavior, we start from the false-negative configuration and add a single extra rule only to the KG inference rules:
squeegee speed<LSL→aperture overfill.

In this configuration, the KG may infer aperture overfill—and downstream causal edges—in cases where the expert ground truth does not. This controlled introduction of mismatched rules allows us to tune distributions in the synthetic-data factory and to interpret the resulting shifts in chain precision and chain recall before transitioning from synthetic evaluation to field trials with domain experts in both low-volume and high-volume production environments. The metric values reported in Table 4 correspond to this final perturbed configuration.

### 7. Discussion

The experimental results confirm that the proposed physics-aware causal reasoning framework produces deterministic, explainable, and traceable inferences for root-cause analysis in surface-mount assembly. The ontology-driven approach establishes an explicit semantic structure linking process data, specifications, causal rules, and corrective actions, demonstrating how reasoning and provenance can coexist in a single governed knowledge graph (KG). This section discusses the practical implications of these findings, and outlines current limitations and future extensions.

### 7.1 Industrial Applicability

For industrial practitioners, the practical value lies in the framework's explainability and standards alignment. Beyond explainability, the operational value is reducing diagnosis latency and triage burden during excursions: instead of manually correlating heterogeneous logs across printing, placement, reflow, and inspection systems, engineers receive an instance-level RCA packet (causal chain, root causes, and recommended actions) that is traceable to its evidence and can be used to prioritize containment, confirm hypotheses, and accelerate corrective-action selection. While the present evaluation emphasizes causal-chain fidelity and provenance, these outputs are designed to translate directly into faster investigations and smaller candidate-cause sets in production workflows. Every defect instance is accompanied by a causal chain that can be traced back to measurement data, specification documents, and rule logic through prov: wasDerivedFrom, prov: used, and wasldentifiedBy links. This level of traceability supports engineering investigations, compliance audits, and continuous improvement programs in manufacturing execution (MES) and quality management (QMS) systems.

The use of BFO, IOF, RO, and PROV ensures interoperability with emerging digital-thread standards and industrial ontologies, allowing integration into enterprise architectures without semantic loss. Furthermore, the declarative nature of SPARQL templates enables domain engineers to extend or modify reasoning logic without reprogramming. In practice, this means that process engineers can augment the causal library as new materials, equipment, or defect modes emerge. The ontology thus functions both as a diagnostic reasoning engine and as a knowledge repository that accumulates structured manufacturing intelligence over time.

### 7.2 Current Limitations

Despite its promising performance, several limitations remain. First, the current knowledge base and rule set were derived from synthetic datasets with engineered variability and, although informed by sampled factory data, do not yet reflect the full statistical diversity and data quality issues present in production-scale environments. Scaling to live deployments will require more automated methods for data ingestion, identity alignment, and noise handling, as well as extraction of causal knowledge from semi-structured and unstructured sources such as FMEA, 8D reports, and equipment logs. In that context, the explicit PROV-O modeling of activities, agents, and entities in our knowledge graph becomes especially valuable, because it provides machine-readable provenance for each extracted assertion and supports auditability of LLM- and agent-based automation. Natural language processing (NLP) pipelines, large-language-model-assisted extraction, and agentic AI workflows are promising tools to assist experts in these tasks and to improve efficiency without ceding semantic control. Second, causal completeness is limited by rule coverage. This limitation is inherent to any symbolic system: the inferred causal knowledge can only be as rich as the physics- and expert-derived rule catalog from which it is generated. The present work therefore focuses on a transparent, deterministic backbone in which every inferred link is traceable, auditable, and grounded in explicit specifications, measurements, and rules. The ontology only captures mechanisms and conditions explicitly encoded by experts and derived from the literature. Unobserved but plausible causal relation-ships, such as humidity-viscosity interactions identified by experts during evaluation, remain outside the reasoning boundary. This underscores the need for hybrid learning approaches that can suggest new candidate rules or reweight existing ones based on data, while maintaining logical consistency with the ontology.

Third, while reasoning performance was stable for the synthetic experiments and 30 simulated shifts of 5000 PCBs each, scaling to continuous production will require attention to computational aspects. SPARQL query execution and OWL 2 DL reasoning may need optimization through indexing strategies, caching, incremental reasoning, and partitioning of the KG. Ontology maintenance and versioning also present practical challenges, as causal definitions evolve with process changes, new products, and equipment upgrades. Provenance tracking should therefore extend not only to instances but also to the evolution of rule sets and ontology releases.

Uncertainty handling remains an open issue. The current inferencing pipeline is deterministic and does not propagate confidence values or likelihoods associated with measurements, model predictions, or expert judgments. In real manufacturing environments, incomplete, noisy, or conflicting evidence is common. For example, paste viscosity measurements may exhibit sensor error and lab-to-line drift on the order of 5-10%, so hard thresholds around specification limits can misclassify borderline cases and either overstate or understate causal responsibility. Reasoning frameworks must therefore accommodate probabilistic or fuzzy information while preserving semantic rigor. Future work will annotate observations and causal chains with quantitative or ordinal confidence intervals, and investigate the integration of probabilistic relational models and Bayesian updates with the symbolic layer.

The final limitation concerns scalability. The present case study operates on synthetic line segments with thousands of boards per run, whereas industrial SMT lines routinely produce on the order of O(10⁵-10⁶) boards per month across multiple products and variants. At those scales, naive recomputation of inferences over a monolithic knowledge graph will be insufficient. We anticipate the need for incremental reasoning, partitioned or product-specific knowledge graphs, and caching strategies that reuse previously computed causal fragments as process conditions drift over time.

The framework demonstrates that symbolic reasoning grounded in manufacturing physics and formal semantics can achieve near-expert-level causal accuracy while ensuring explainability and provenance. At the same time, the findings emphasize the importance of scalability, richer data realism, and adaptive learning to make such systems sustainable in industrial contexts. The next section summarizes the contributions of this work and outlines future research directions.

### 8 Non-Limiting Conclusions

The above presented an ontology-based approach to explainable root-cause analysis for surface-mount assembly. The central contribution is a causal ontology that integrates Basic Formal Ontology (BFO) and the Industrial Ontologies Foundry (IOF), reuses causal relations from the Relations Ontology (RO), and adopts the W3C PROV Provenance Ontology (PROV-O) to represent specifications, observations, conformance assessments, causal links, and corrective actions in a single governed knowledge graph. On this foundation, a deterministic, auditable reasoning method was implemented: physics-informed rules evaluate measured values against prescribed limits and identify FailureCause instances with provenance, SPARQL templates materialize causal edges and designate RootCause nodes, and decision objects bind actions to the earliest defensible causes. The case study on solder bridging and open circuits, averaged over multiple synthetic shifts, validated that the method yields accurate and repeatable causal chains with complete traceability.

The significance of this contribution is threefold. First, it shows that physics-aware explanations can be encoded as first-class, queryable structures that stand alongside measurements and specifications. This produces causal chains that are both human-interpretable and machine-verifiable. Second, the use of BFO/IOF, RO, and PROV provides semantic rigor and interoperability, allowing the knowledge graph to coexist with enterprise tooling and to evolve with changes in products, equipment, and processes. Third, the execution layer is transparent by construction: rules are declarative, inserts are annotated with provenance, and description-logic reasoning maintains global coherence. Together, these properties make the system amenable to verification, audit, and continuous improvement, which are necessary for sustainable zero-defect manufacturing.

Future work can proceed along four directions. Neurosymbolic integration: learned models, for example graph neural networks or other representation learners, can assist in proposing candidate edges, ranking causal chains, or identifying latent mechanisms, while the ontology provides semantic constraints and provenance to keep such out-puts explainable. Scaling and streaming: deploying the method on live factory lines will require robust identity resolution across systems, SHACL-based data-quality validation at ingest, and incremental reasoning strategies that preserve latency under continuous updates. Rule generalization and uncertainty: the rule catalog will be extended to cover a broader spectrum of defect mechanisms, and principled treatments of uncertainty (for example belief annotations on causes and edges or probabilistic scoring of chains) will be investigated, while preserving decidability of the core ontology. Broader domain coverage: the same modeling patterns can be applied beyond solder bridging and opens, to voids, wetting failures, and upstream design-for-X (DfX) constraints, by reusing the ontology and adding domain-specific rules.

In summary, the work shows that causal reasoning for manufacturing does not need to trade explainability for performance. By combining standards-aligned semantics with physics-informed rules and provenance-by-design, the approach delivers credible and reproducible explanations that are actionable in practice and extensible in scope. We view this symbolic foundation as an explainable backbone on which neurosymbolic decision systems for zero-defect manufacturing can be built and refined with real factory data.

### Computer-Implemented System

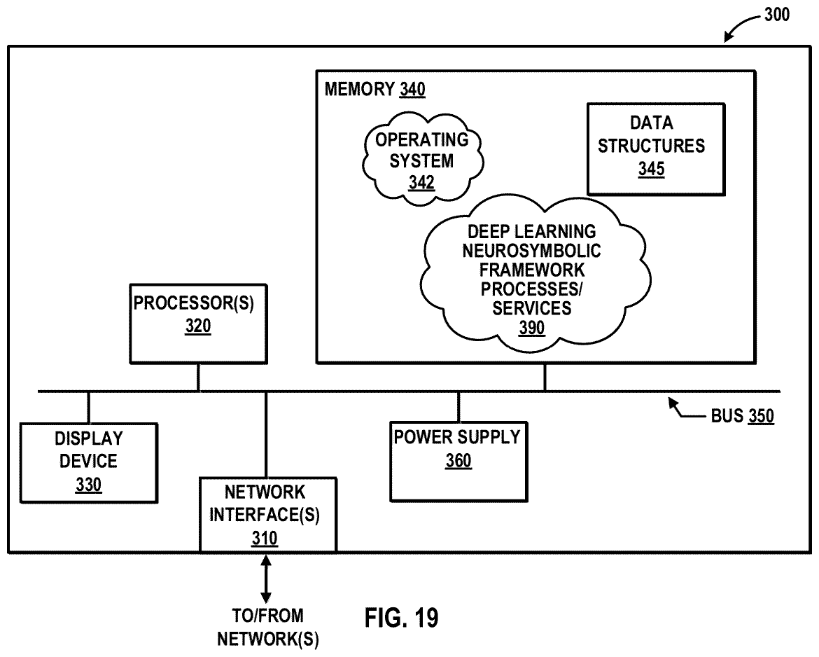

FIG. 19 is a schematic block diagram of an example device 300 that may be used with one or more embodiments described herein, e.g., implementing aspects of framework 102 shown in FIG. 1.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.). Device 300 can also include or otherwise communicate with a display interface device 330 which can include one or more input/output devices that enable a user to input data, and to view or otherwise access output data. Input/output devices can include but are not limited to a monitor, a touch-screen, a speaker, a keyboard, a mouse, and the like.

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the framework 102 and associated methods outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include Deep Learning Neurosymbolic Framework processes/services 390, which can include aspects of the methods and/or implementations of various modules (of framework 102) described herein. Note that while Deep Learning Neurosymbolic Framework processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Deep Learning Neurosymbolic Framework processes/services 390 is shown as a standalone process, those skilled in the art will appreciate that this process may be executed as a routine or module within other processes.

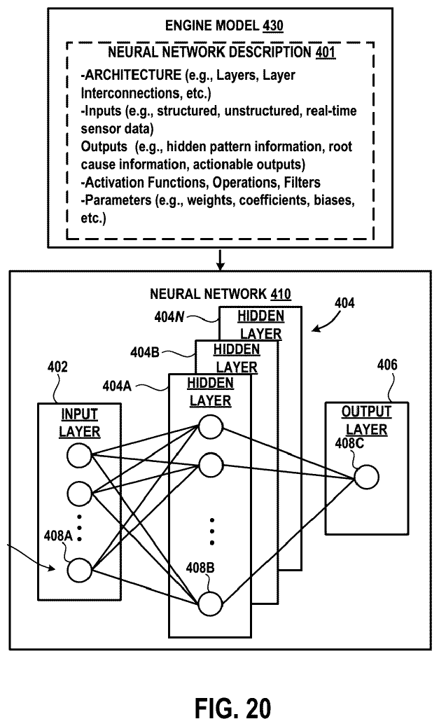

FIG. 20 is a schematic block diagram showing a simplified example of a neural network architecture 400 that may be used with one or more embodiments described herein, e.g., as a component of framework 102 shown in FIG. 1. Neural network architecture 400 can be implemented using computing device 300 shown in FIG. 3, e.g., as part of Deep Learning Neurosymbolic Framework processes/services 390.

Architecture 400 includes a neural network 410 defined by an example neural network description 401 in an engine model (neural controller) 430. The neural network 410 can represent a neural network implementation of an ensemble deep neural network shown in FIG. 1. The neural network description 401 can include a full specification of the neural network 410, including the neural network architecture 400. For example, the neural network description 401 can include a description or specification of the architecture 400 of the neural network 410 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 410 reflects the architecture 400 defined in the neural network description 401. The neural network 410 includes an input layer 402, which includes multimodal input data, such as structured, unstructured, and real-time inputs (e.g., imaging data for semiconductors, patient health data, supply chain operations data, etc.). Individual “pieces” of data can correspond to one or more nodes 408. Neural networks may communicate with rule-based logic and causal reasoning modules as shown in FIG. 1.

The neural network 410 includes hidden layers 404A through 404N (collectively “404” hereinafter). The hidden layers 404 can include n number of hidden layers, where n is an integer greater than or equal to one. The number of hidden layers can include as many layers as needed for a desired processing outcome and/or rendering intent. The neural network 410 further includes an output layer 406 that provides an output (e.g., hidden pattern information, root cause information, actionable output(s)) resulting from the processing performed by the hidden layers 404.

The neural network 410 in this example can be a multi-layer neural network of interconnected nodes. Each node can represent a piece of information. Information associated with the nodes is shared among the different layers and each layer retains information as information is processed. In some cases, the neural network 410 can include a feed-forward neural network, in which case there are no feedback connections where outputs of the neural network are fed back into itself. In other cases, the neural network 410 can include a recurrent neural network, which can have loops that allow information to be carried across nodes while reading in input.

Information can be exchanged between nodes through node-to-node interconnections between the various layers. Nodes of the input layer 402 can activate a set of nodes in the first hidden layer 404A. For example, as shown, each of the input nodes of the input layer 402 is connected to each of the nodes of the first hidden layer 404A. The nodes of the hidden layer 404A can transform the information of each input node by applying activation functions to the information. The information derived from the transformation can then be passed to and can activate the nodes of the next hidden layer (e.g., 404B), which can perform their own designated functions. Example functions include convolutional, up-sampling, data transformation, pooling, and/or any other suitable functions. The output of the hidden layer (e.g., 404B) can then activate nodes of the next hidden layer (e.g., 404N), and so on. The output of the last hidden layer can activate one or more nodes of the output layer 406, at which point an output is provided. In some cases, while nodes (e.g., nodes 408A, 408B, 408C) in the neural network 410 are shown as having multiple output lines, a node has a single output and all lines shown as being output from a node represent the same output value.

In some cases, each node or interconnection between nodes can have a weight that is a set of parameters derived from training the neural network 410. For example, an interconnection between nodes can represent a piece of information learned about the interconnected nodes. The interconnection can have a numeric weight that can be tuned (e.g., based on a training dataset, which may include expert-provided data), allowing the neural network 410 to be adaptive to inputs and able to learn as more data is processed.

The neural network 410 can be pre-trained to process the features from the data in the input layer 402 using the different hidden layers 404 in order to provide the output through the output layer 406. In an example, the neural network 410 can be trained using training data that includes example mappings between multimodal input data and hidden pattern information, root cause information, actionable output(s), etc. Training data can be input into the neural network 410, which can be processed by the neural network 410 to generate outputs which can be used to tune one or more aspects of the neural network 410, such as weights, biases, etc.

In some cases, the neural network 410 can adjust weights of nodes using a training process such as backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 410, the output can include values that do not give preference to any particular class due to the weights being randomly selected at initialization. With the initial weights, the neural network 410 may be unable to generate precisely correct information. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 410 can perform a backward pass by determining which inputs (weights) most contributed to the loss of the neural network 410, and can adjust the weights so that the loss decreases and is eventually minimized.

A derivative of the loss with respect to the weights can be computed to determine the weights that contributed most to the loss of the neural network 410. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 410 can include any suitable neural or deep learning network. One example includes a graph neural network. In other examples, the neural network 410 can represent or otherwise incorporate aspects of other types of neural or deep learning networks, such as an autoencoder, a convolutional neural network (CNN), a deep belief nets (DBNs), and recurrent neural networks (RNNs), classifier(s), discriminator(s), generative adversarial networks, large language models (LLMs), transformer networks, etc.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A computer-implemented method for defect diagnosis using neurosymbolic techniques, comprising:
ingesting, by at least one processor, multimodal manufacturing data comprising specification requirements and measured observations for a manufacturing process;
mapping the multimodal manufacturing data to an ontological knowledge graph that encodes domain entities and causal dependencies for the manufacturing process;
executing one or more physics-informed rules expressed as queries over the ontological knowledge graph to evaluate conformance between the measured observations and the specification requirements and, responsive to detecting at least one deviation, inserting into the ontological knowledge graph at least one failure-cause assertion corresponding to the at least one deviation and at least one directed causal edge linking a node corresponding to the at least one failure-cause assertion to a node corresponding to an observed defect;
assembling, by traversing the ontological knowledge graph, a causal chain that links the observed defect to at least one failure cause through one or more intermediate mechanisms represented in the knowledge graph, the causal chain comprising nodes corresponding to the failure-cause assertions and the observed defect and edges corresponding to the directed causal edges; and
generating a remedial instruction based on the causal chain by identifying, for at least one failure cause in the causal chain, at least one modification to at least one process parameter associated with the manufacturing process, the remedial instruction causing a manufacturing system to modify at least one process parameter for subsequent execution of the manufacturing process to reduce incidence of the observed defect.

2. The computer-implemented method of claim 1, wherein executing the one or more physics-informed rules comprises, for each measured observation, evaluating a corresponding specification-observation pair and, responsive to determining that the measured observation does not conform to a corresponding specification requirement, instantiating a conformance-assessment record that classifies the specification-observation pair as conforming or nonconforming.

3. The computer-implemented method of claim 2, wherein the conformance-assessment record is modeled in the ontological knowledge graph as a provenance-bearing activity that consumes the specification-observation pair as input and is linked to the at least one failure-cause assertion as an identification activity that records that the failure-cause assertion was identified based on the specification-observation pair.

4. The computer-implemented method of claim 1, wherein mapping the multimodal manufacturing data to the ontological knowledge graph further comprises representing, for at least one failure mechanism, a disposition that inheres in a material product and that is grounded in at least one parameter quality, a realization process in which the disposition is manifested under a triggering manufacturing process, and a failure-cause entity that records the disposition and the realization process as a causal node in the ontological knowledge graph.

5. The computer-implemented method of claim 4, wherein executing the one or more physics-informed rules comprises, responsive to detecting a parameter deviation associated with the at least one parameter quality, asserting in the ontological knowledge graph that the parameter deviation provides a physical basis for the disposition, linking the disposition to the realization process that is triggered by the manufacturing process, and associating the failure-cause entity with the parameter deviation, the disposition, and the realization process.

6. The computer-implemented method of claim 1, wherein executing the one or more physics-informed rules comprises applying, by the at least one processor, a library of deterministic rules that encode physics-based constraints of the manufacturing process and relationships among process parameters.

7. The computer-implemented method of claim 6, wherein each deterministic rule in the library is implemented as a declarative query template over the ontological knowledge graph that, when a rule condition is satisfied, asserts a conformance-assessment record, asserts at least one failure-cause entity, and asserts at least one directed causal edge linking the at least one failure-cause entity to either another failure-cause entity or to the observed defect for use in generating the remedial instruction that causes the manufacturing system to modify the at least one process parameter.

8. The computer-implemented method of claim 1, wherein the remedial instruction causes the manufacturing system to perform at least one of: updating a process recipe, routing or holding a product unit, scheduling maintenance, or generating a process-control alert.

9. The computer-implemented method of claim 1, wherein the ontological knowledge graph represents processes, equipment, product units, defects, and causal relations.

10. The computer-implemented method of claim 1, wherein assembling the causal chain comprises ordering a plurality of failure-cause entities and at least one defect entity as a directed graph in which edges represent that a given effect is directly causally influenced by a corresponding cause and deriving, by graph traversal, multi-step causal paths from parameter-level causes to the observed defect.

11. The computer-implemented method of claim 1, wherein assembling the causal chain further comprises designating, as a root cause, a failure-cause entity that is associated with the observed defect but that lacks any upstream directly-causally-influencing failure-cause entity in a subgraph restricted to the observed defect, and wherein the root cause is used as a basis for selecting the remedial instruction that causes the manufacturing system to modify the at least one process parameter.

12. The computer-implemented method of claim 11, wherein generating the remedial instruction comprises selecting at least one corrective-action specification that is associated, in the ontological knowledge graph, with the root cause, the corrective-action specification prescribing at least one particular process change that is executable by the manufacturing system and mitigates the root cause.

13. The computer-implemented method of claim 1, wherein generating the remedial instruction further comprises constructing, by the at least one processor, a root-cause-analysis packet that includes an identifier of a product unit exhibiting the observed defect, the causal chain, at least one identified root cause, the remedial instruction, and provenance links to the specification requirements, the measured observations, and the physics-informed rules used to generate the causal chain.

14. The computer-implemented method of claim 1, wherein each declarative query template comprises an update query over the ontological knowledge graph that, when a rule condition is satisfied, constructs the at least one failure-cause assertion and the at least one causal edge together with provenance data identifying at least one of the specification requirements, the measured observations, and a triggering rule identifier.

15. The computer-implemented method of claim 1, wherein mapping the multimodal manufacturing data to the ontological knowledge graph comprises instantiating, in the ontological knowledge graph, respective information entities corresponding to the specification requirements and the measured observations and linking each measured observation to a corresponding specification requirement via one or more ontological relations that encode that the measured observation is evaluated against the corresponding specification requirement.

16. The computer-implemented method of claim 1, further comprising, for a selected product unit, executing a first causal query over the ontological knowledge graph that returns immediate cause-effect pairs for the observed defect on the selected product unit and executing a second causal query that returns one or more corrective actions associated with root causes present in the causal chain.

17. A system for defect diagnosis using neurosymbolic techniques, comprising:
at least one processor; and
at least one non-transitory memory storing instructions that, when executed by the at least one processor, cause the processor to:
ingest multimodal manufacturing data comprising specification requirements and measured observations for a manufacturing process;
map the multimodal manufacturing data to an ontological knowledge graph that encodes domain entities and causal dependencies for the manufacturing process;
execute one or more physics-informed rules derived from the ontological knowledge graph to evaluate conformance between the measured observations and the specification requirements and, responsive to detecting at least one deviation, insert into the ontological knowledge graph at least one failure-cause assertion and at least one causal edge linking the deviation to an observed defect;
assemble a causal chain that links the observed defect to at least one failure cause through one or more intermediate mechanisms represented in the ontological knowledge graph; and
generate at least one remedial instruction based on the causal chain, the at least one remedial instruction identifying at least one modification to at least one process parameter of a manufacturing system for reducing incidence of the observed defect.

18. The system of claim 17, wherein the at least one remedial instruction causes, or recommends causing, a change to a process-control recipe parameter within a manufacturing execution system (MES) or advanced process control (APC) system.

19. The system of claim 17, wherein the instructions that cause the at least one processor to execute the one or more physics-informed rules further cause the at least one processor, for each detected deviation, to create in the ontological knowledge graph a conformance-assessment entity that (i) links the specification requirements and the measured observations used to detect the deviation to a corresponding failure-cause assertion and (ii) is queryable as provenance when generating the remedial instruction.

20. A non-transitory computer-readable medium storing instructions that, when executed by one or more processors, cause the one or more processors to:
ingest multimodal operational data comprising specification requirements and measured observations for at least one process that produces a physical product;
map the multimodal operational data to an ontological knowledge graph that encodes domain entities and causal dependencies for the at least one process;
execute one or more physics-informed rules derived from the ontological knowledge graph to evaluate conformance between the measured observations and the specification requirements and, responsive to detecting at least one deviation, insert into the ontological knowledge graph at least one failure-cause assertion and at least one causal edge linking the deviation to an observed outcome;
assemble a causal chain that links the observed outcome to at least one failure cause through one or more intermediate mechanisms represented in the ontological knowledge graph; and
generate a neurosymbolic diagnostic output based on the causal chain, the neurosymbolic diagnostic output including at least one remedial recommendation that identifies at least one candidate modification to at least one process parameter associated with the at least one process.
